(19) United States
(12) Patent Application Publication
(10) Pub. No.: US 2015/0235262 A1
(43) Pub. Date: Aug. 20, 2015

(54) METHOD, SYSTEM AND COMPUTER PROGRAM PRODUCT FOR ENHANCING BUSINESS GROWTH, MARKETING AND ANALYSIS

(71) Applicant: PharmaCommunications Holdings Inc., Markham (CA)

(72) Inventors: Ronald MAHEU, Markham (CA); Nicole ARCHAMBAULT, Markham (CA); James Jeremy BALDWIN, Aurora (CA); Albert ARLOO, Markham (CA); Stuart BUCKLEY, Pickering (CA)

(73) Assignee: PharmaCommunications Holdings Inc., Markham (CA)

(21) Appl. No.: 14/180,574

(22) Filed: Feb. 14, 2014

(51) Int. Cl. G06Q 30/02; G06Q 10/08

(52) U.S. Cl. CPC G06Q 30/0255; G06Q 10/087; G06Q 30/0226

(57) ABSTRACT

This invention relates to methods, systems and computer program products to improve communication and business transactions between healthcare professionals and consumers, for the purchase of product and services and in particular for marketing products and services, and providing analytical services to the pharmaceutical and consumer health care and medical industry. The invention also relates to mining computer data for segmentation and profiling information to assist in future growth.

### FIELD OF INVENTION

This invention relates to methods, systems and computer program products to improve communication and business transactions between healthcare professionals and consumers, for the purchase of product and services and in particular for marketing products and services, and providing analytical services to the pharmaceutical and consumer health care and medical industry. The invention also relates to statistically analyzing computer data for segmentation and profiling information to assist in future growth.

### BACKGROUND TO INVENTION

It is the general goal of many businesses to increase profits through the efficient marketing and sale of their product and services. Various marketing and sales campaigns have hereto for being designed and implemented to fulfill these goals. In recent years many companies have turned to the internet to increase their sales through e-commerce. Various methods, systems and computer programs have been implemented in the prior art. Furthermore, the health care industry has adopted some of these systems, methods and computer programmes as outlined below.

U.S. Pat. No. 835,725 issued on Dec. 18, 2012 and relates to systems, methods, and apparatus for determining motivator counts associated with purchase selections. A data store can be configured to store purchase selections of respective products. A server can be configured to determine an incremental purchase time between a first purchase selection of the purchase selections and a second purchase selection of the purchase selections. Further, the server can be configured to determine a standard deviation of incremental purchase times between respective purchase selections of the purchase selections. Furthermore, the server can be configured to increment a prime motivator count associated with the second purchase selection based on the incremental purchase time and the standard deviation.

Furthermore U.S. Pat. No. 8,121,868 issued on Feb. 21, 2012 and teaches systems and methods for providing targeted content to a patient who has received a prescription for medication. The systems and methods generally provide the content prior to the Point of Sale (POS) of the actual prescription allow patients to review the content and possibly act on it prior to actually obtaining the medication. Depending on embodiment, the content may be provided by a pharmacy at or around the time of dispensing or by a physician at or around the time of prescribing.

Also U.S. Pat. No. 7,690,557 issued on Sep. 15, 2009 and relates to a computer-implemented arrangement facilitates purchases by multiple card members using respective transaction instruments, each transaction instrument being associated with a single tax-advantaged account. A merchant's requested payment from a point of sale device for a purchase by a card member against the tax-advantaged account is received by a host computer system, which determines whether the requested charge is associated with a tax-advantaged qualified expense. The tax-advantaged account is credited with points associated with the value of the charge only if the charge is determined to be for to covered tax-advantaged expense. This process occurs for all other card members making transactions associated with the same tax advantaged account.

Moreover U.S. Pat. No. 7,949,543 issued May 24, 2011 and relates to methods, systems, and computer-program products allow a credit or charge card issuer to promote healthcare information technology (HIT) products to physician card members that are affiliated with a healthcare organization, such as a preferred-provider organization (PPO). In an embodiment, the PPO endorses at least one HIT product, such as an electronic medical record (EMR), and the PPO identifies he endorsed HIT product to a transactional card provider. The transactional card provider then identifies at least one supplier of the endorsed HIT product and negotiates a discount on the endorsed HIT product when purchased from identified HIT supplier using a financial transaction instrument issued by the transactional card provider. The financial transaction instrument may be provided to the physician card member, who may purchase the endorsed HIT product from the identified supplier at the negotiated discount.

US publication 20120053958 published Mar. 1, 2012 teaches a system and method whereby a health care provider is offered a benefit in exchange for the performance of specified activities of a patient. The patient activities may take the form of a purchase of prescribed or recommended products or services, such as prescription drugs, undergoing prescribed or recommended health care procedures, or participation in health-oriented programs or activities, such as a specified exercise regimen. In one embodiment, a benefit is provided to a health care provider upon verification of the adherence of a patient to a specified health-related activity. In one embodiment a benefit is provided to both a provider and a patient upon verification of the patient's adherence to a specified health-related activity. In one embodiment, patient adherence is facilitated, by distributing benefit cards to patients wherein the benefit card identifies the patient as registered in an adherence program and is associated with a benefit account for receiving program benefits. in one embodiment, the benefit card account is associated with the patient's health or prescription insurance account so as to verify adherence using claims submitted to the patient's health insurer. In one embodiment, the benefit card operates as a payment card allowing the cardholder to redeem benefits.

Yet another system is illustrated in US Pub 20100211493 which was published Aug. 19, 2010 and illustrates a computer-implemented method and system to facilitate a purchase by a card member using a transaction instrument. A request to charge a tax-advantaged account for a transaction using the transaction instrument is received at a host computer. A determination is made whether the charge is for a covered tax-advantaged expense. The tax-advantaged account is credited with points associated with the value of the charge only if the charge is determined to be for a covered tax-advantaged expense.

Furthermore US Pub 20030225619 was published on Dec. 4. 3003 and relates to a system for exchanging and valuing points or rewards from a plurality of loyalty programs using a “settlement point” in a clearinghouse to settle, convert, credit and debit points between accounts regardless of the type of goods or services. The points are underwritten using assets and guarantees held by a custodian, relying on actuarial estimates of redemption. The points are also used as assets for securities, thereby facilitating the valuing and liquidity of the settlement points, or as assets to secure financial or insurance services.

It is an object of this invention to provide more efficient methods, systems and computer program products to improve efficient communication with healthcare, professionals and consumers.

It is another object of this invention to market services, and analytics for the pharmaceutical and consumer health care and medical industry.

It is an aspect of this invention to provide a method of providing a benefit to a user of a healthcare computer system through the internet comprising: identifying at least one healthcare provider wherein the identification comprises storing product and/or service data from the healthcare provider and the name of the healthcare provider in a database accessed through the internet; identifying at least one healthcare user accessing the product and/or service, wherein the identification includes storing data regarding the purchase or acceptance of the product or service and the name of the healthcare user in the data base; associating the healthcare provider with the healthcare user and storing the associated data in the database; and generating a benefit to one of the healthcare provider or healthcare user.

It is another aspect of this invention to provide a system to provide a benefit to a healthcare user comprising: a computer server connected to the interact, the computer server having a computer memory for storing sales, support, reporting, fee for service, and warehouse management; at least one healthcare provider computer connected to the internet for connecting with the computer server to enter identification data regarding the healthcare provider product and/or services as the name of the healthcare provider; at least one healthcare user computer connected to the internet for connecting with the computer server to enter identification data regarding the purchase or acceptance of the product or service; the computer server associating the healthcare provider identification data with the healthcare user identification data to provide a benefit to one of the healthcare provider or healthcare user.

Yet another aspect of this invention relates to a non transitory computer medium for providing instruction to identify the at least one healthcare provider wherein the identification comprises storing product and/or service data from the healthcare provider and the name of the healthcare provider in a database accessed through the internet; identify the at least one healthcare user accessing the product and/or service, wherein the identification includes storing data regarding the purchase or acceptance of the product or service and the name of the healthcare user in the data base; associate the healthcare provider with the healthcare user and storing the associated data in the database; and generate a benefit to one of the healthcare provider or healthcare user.

These and other objects and features will now be described in relation to the following drawings.

### BRIEF DESCRIPTION OF THE DRAWINGS

FIG. 1 is a schematic computer architecture drawing of the

FIG. 2 is an overview of the general components of the system methodology.

FIG. 3 is a flowchart relating to the various components in the health loyalty master flowchart system.

FIG. 4 is a flowchart of the Customer Subsidiary/Reimbursement Program.

FIG. 5 is a general flowchart of the Customer Subsidiary/Reimbursement Program.

FIG. 6 is flowchart showing the various steps for a Fee For Service Client Upload Portal.

FIG. 7 is a flowchart for a Fee For Service Internal Processes.

FIG. 8 is a flowchart for Fee For Service Internal Process Data Entry.

FIG. 9 is a flowchart for Fee For Service Internal Processes Data Entry.

FIG. 10 is a flowchart for Fee For Service Internal Processes Quality Control.

FIG. 11 is a Fee For Service internal Process Re-quality Control.

FIG. 12 is a flowchart for Fee For Service internal Processes Completed Invoices.

FIG. 13 is a flowchart for Fee For Service internal Processes General Payment Files.

FIG. 14 is a flowchart for Fee For Service internal Processes For Accounts Paid.

FIG. 15 is a flowchart for a Health Loyalty Club program.

FIG. 16 is a flowchart for a Health Loyalty Coupons Coupon Display Program.

FIG. 17 is a flowchart for Health Loyalty Coupons—Coupons Print.

FIG. 18 is a flowchart for Reporting—Display Process Program.

FIG. 19 is a flowchart for a Reporting Update Process.

FIG. 20 is a flowchart for Pharmaceutical Sales Support.

FIG. 21 is a flowchart for Rep Orders.

FIG. 22 is a flowchart for the Administrator Program.

FIG. 23 is a flowchart for Or Fulfillment Program.

FIG. 24 is a flowchart for Warehouse Management Systems program.

### DETAILED DESCRIPTION OF THE INVENTION

Like parts have been given like numbers throughout the figures. In the drawings, embodiments of the invention as illustrated by way of example, it is expressly understood that the description and drawings are only for the purpose of illustration and as an aid to understanding, and are not intended as a definition of the limits of the invention.

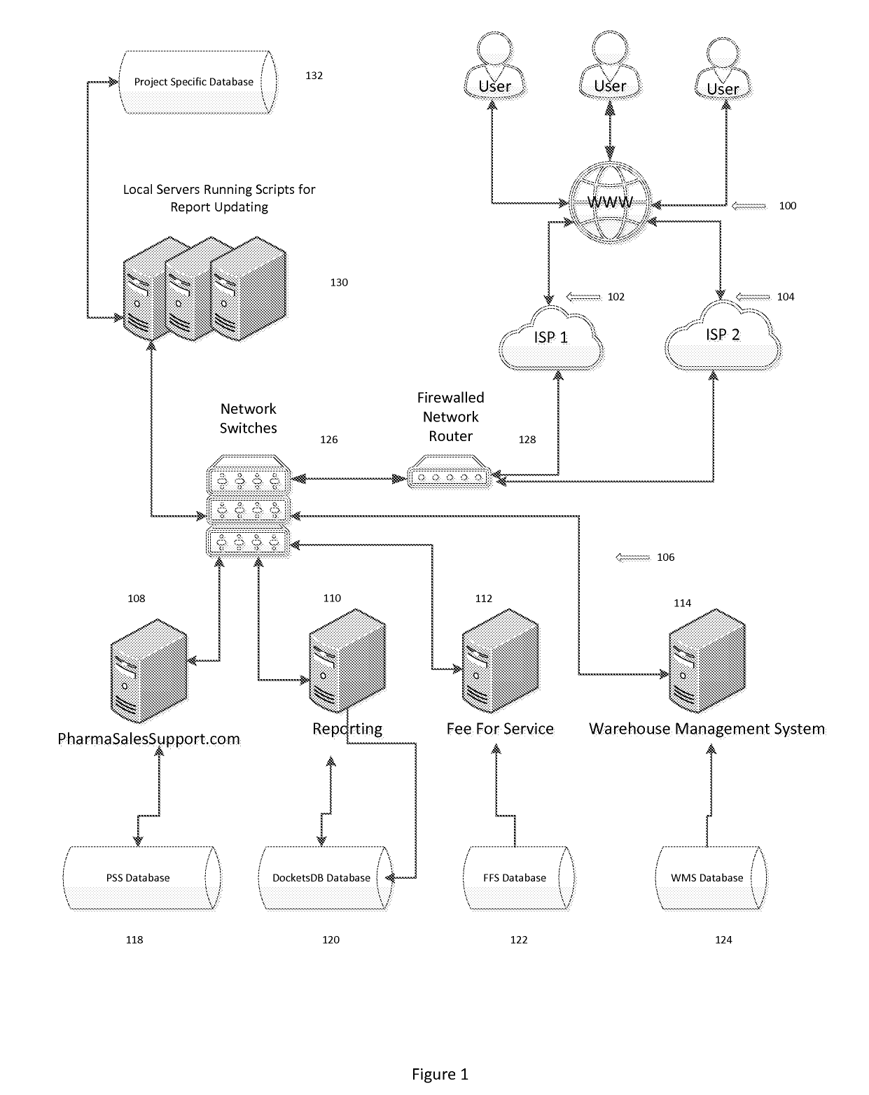

FIG. 1 generally illustrates the components that may be used for the System 100 to be described herein.

In particular, the System 100 can include a number of Internet Service Providers 102 and 104 which provide access to the internet, emails or the like.

The System 100 also includes a plurality of computer servers 106 which for example, can include Pharma Sales Support (PSS) server 108, reporting server 110, Fee For Service (FFS) server 112 and Warehouse Management System (WMS) and server 114.

Each of the service 106 includes an associated PSS database 118, Dockets Database 120, FFS Database 122 and WMS database 124.

The databases 118, 120, 122 and 124 are connected to the servers 108, 110, 112 and 114, respectively. The servers 106 are connected to network switches 126. The network switches are connected to the ISP 102 and 104 behind a firewalled network router 128.

Moreover the System 100 also includes local servers running scripts for report updating 130 having associated projects specific databases 132 connected thereto.

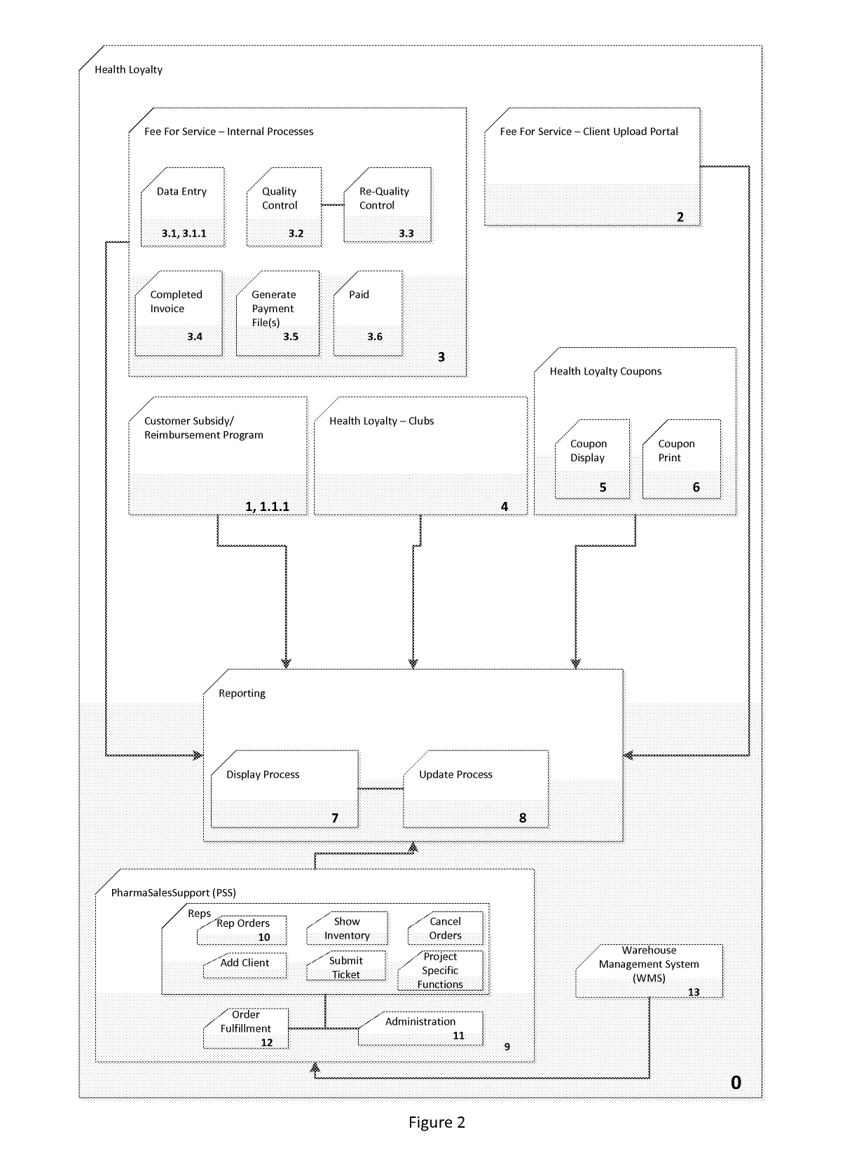

The users shown in FIG. 1 can be vendors or health care providers such as pharmaceutical companies providing product, doctors, nurses or the like providing services, and healthcare users such as patients or customers requiring product or services. FIG. 2 is an overview of the general components of the System 100 methodology.

In particular the System 100 includes Customer Subsidiary/Reimbursement Program 1, and 1.1.1 as well as a Fee For Service (FFS)—Client Upload Portal 2.

Moreover the FFS—internal Processes 3 includes Data Entry 3.1, and 3.1.1, a Quality Control 3.2 module, a Re-Quality Control 3.3, as well as Completed Invoice step 3.4.

Moreover the FFS—Internal Process also includes a Generate Payment file step 3.5 as well as a Paid step 3.6, all of which will be more fully particularized herein.

The System 100 also includes Health Loyalty-Clubs component or method step 4. Moreover health loyalty coupons can be generated which steps include Coupon Display 5 and Coupon Print step 6.

Furthermore the method to be described herein also includes a Reporting and analysis function which will include a Display Process 7 and Update Process 8.

The System 100 to be described herein also includes a PSS component 9 which includes Representatives 9. The steps to be described herein include Rep Orders 10, Show Inventory, Cancel Orders, Add Clients, Submit Ticket and Project Specific Functions.

The PSS component includes Order Fulfillment 12 and Administration step 11 to be described herein.

Finally there is a Warehouse Management System 13.

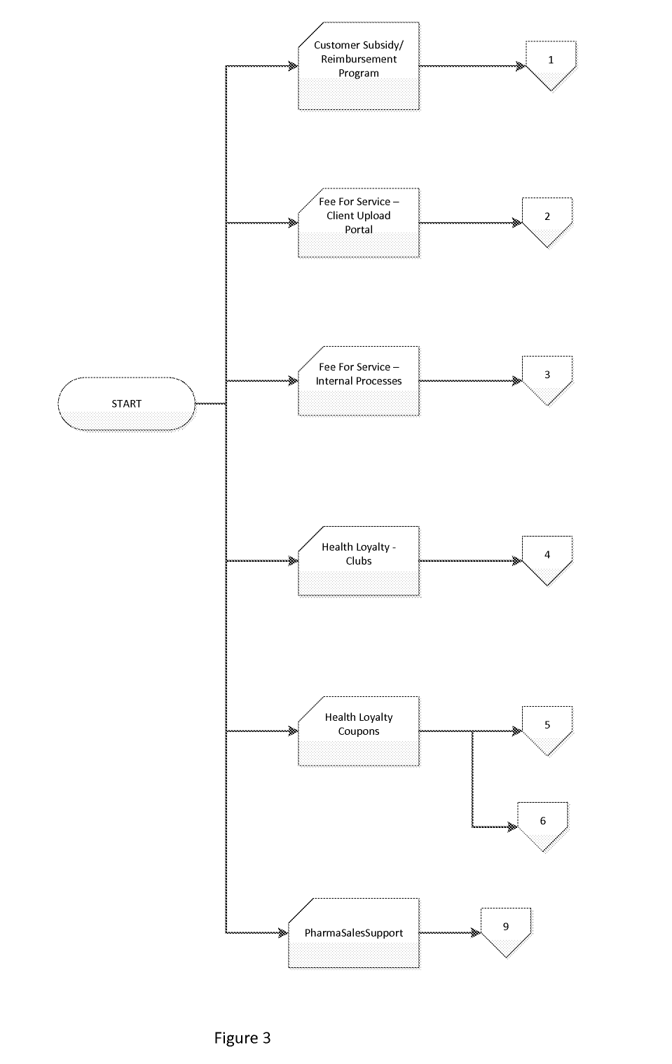

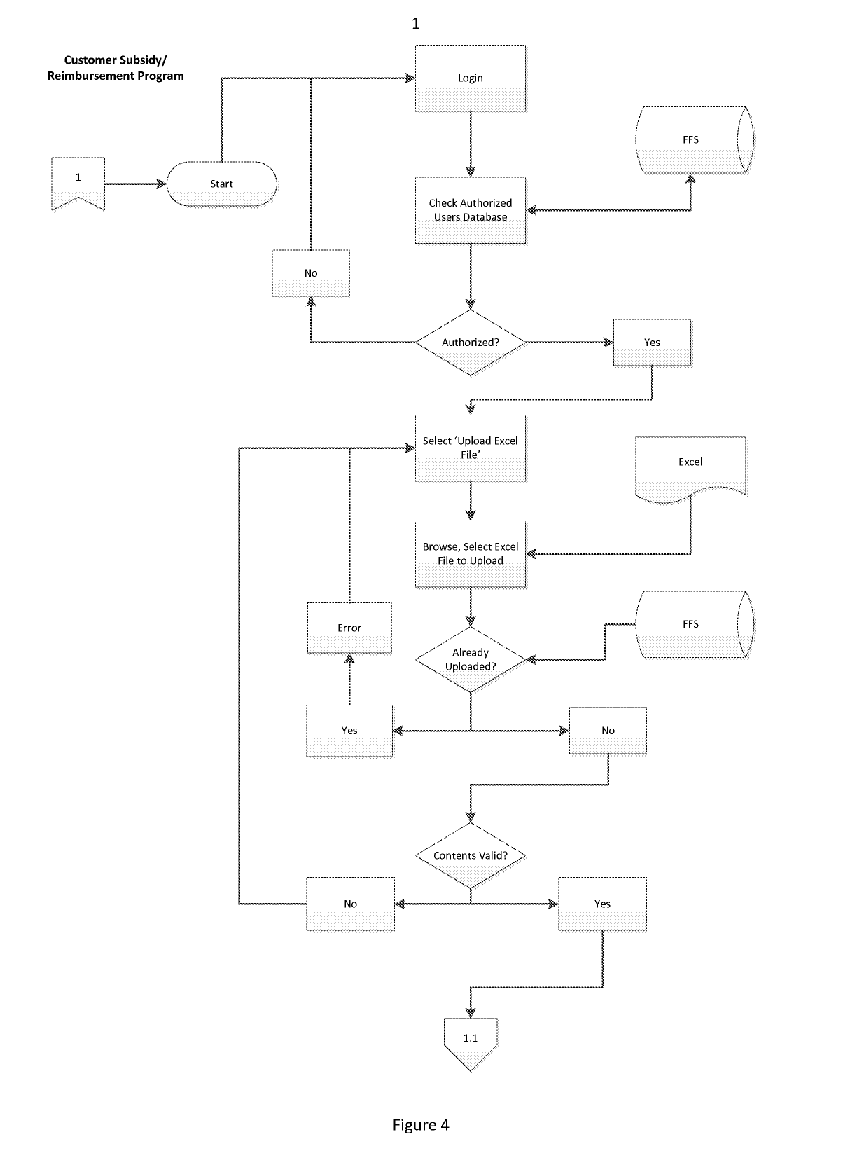

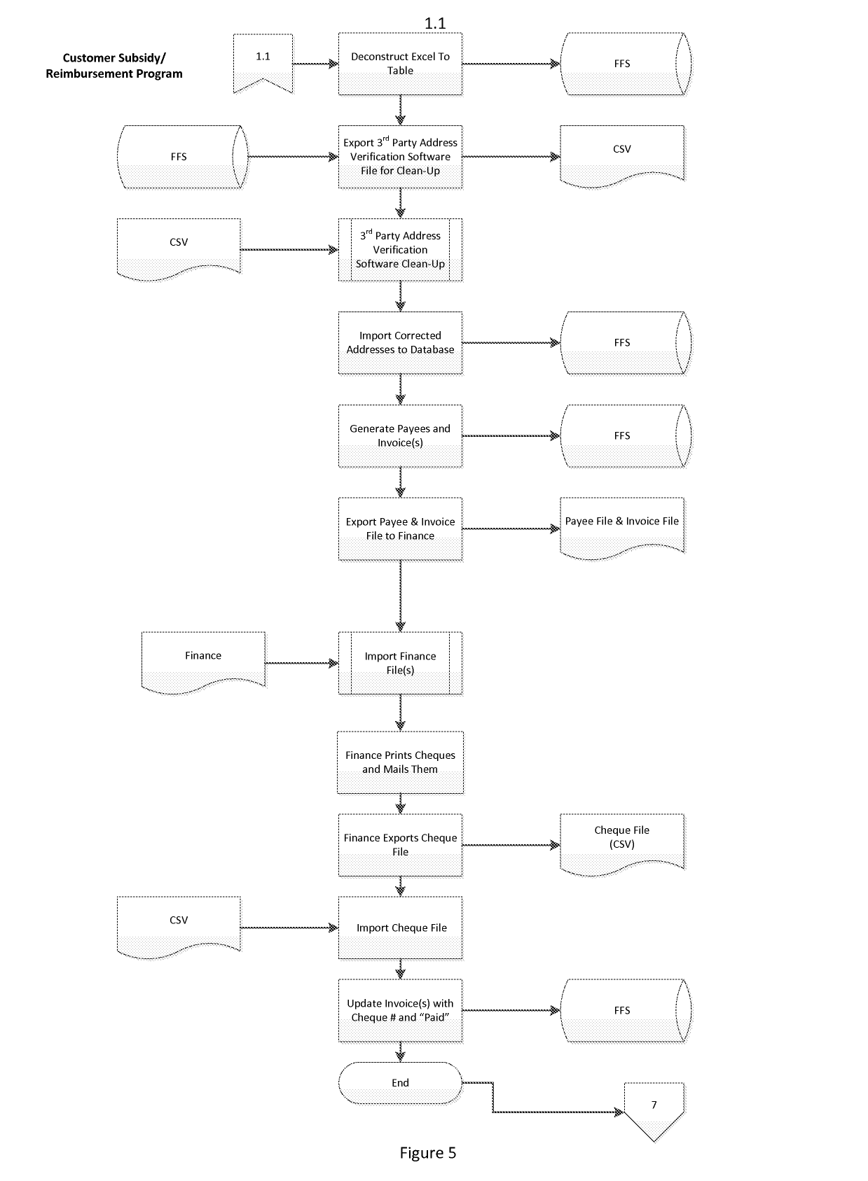

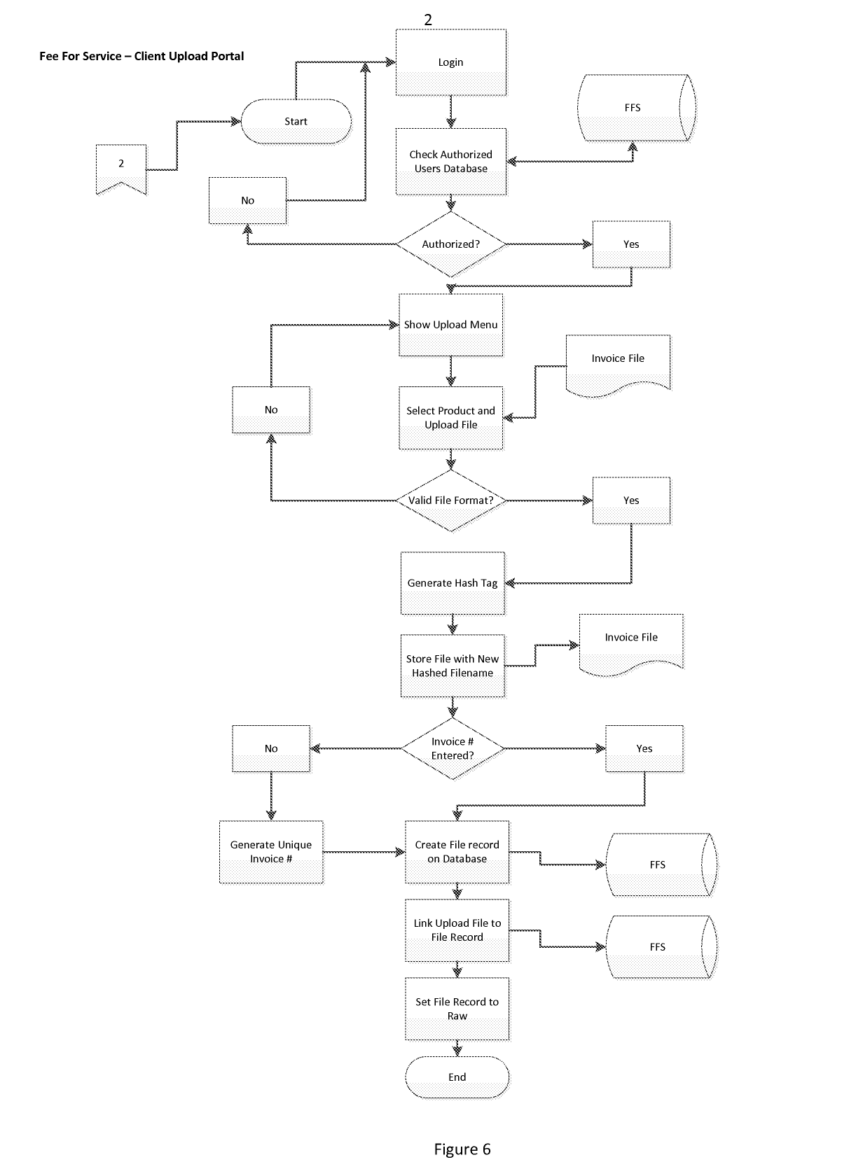

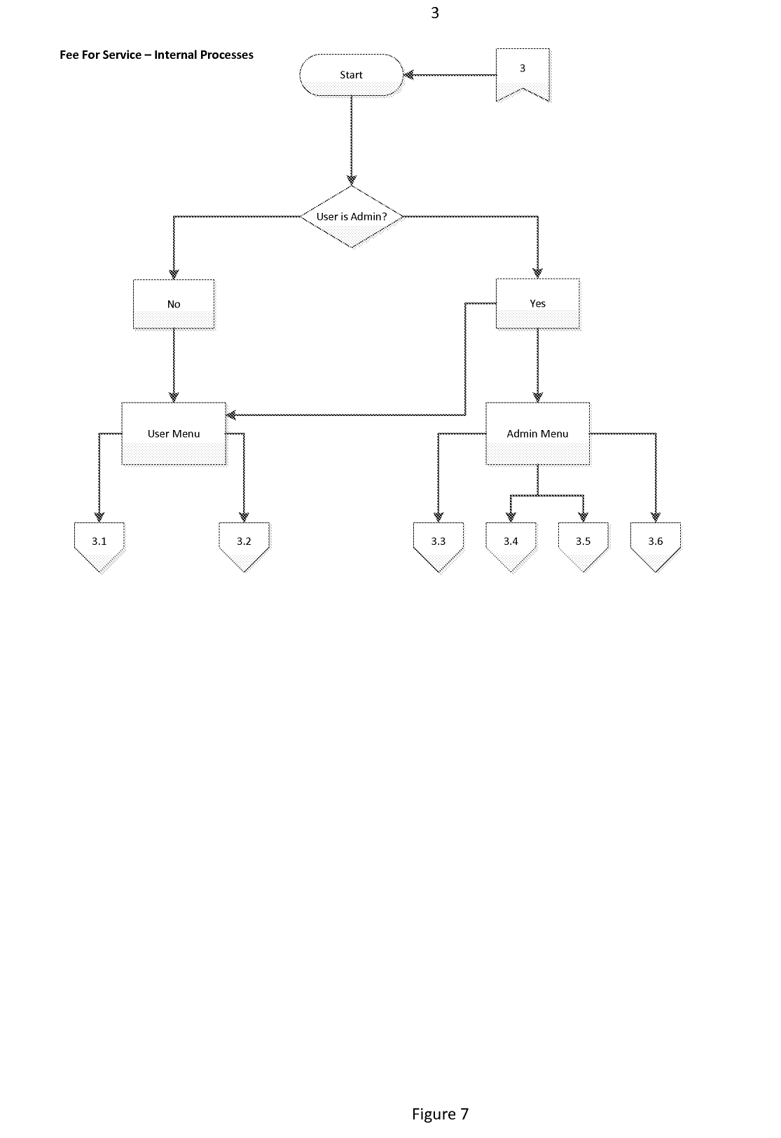

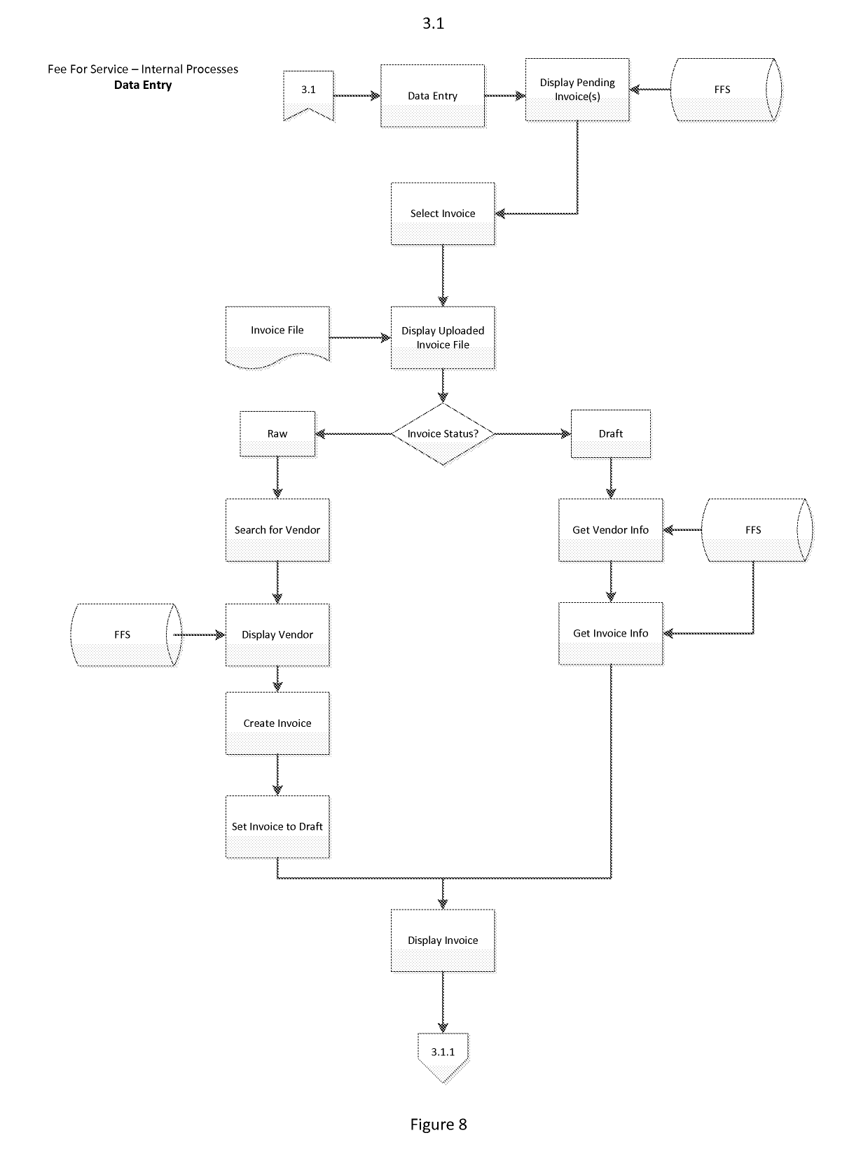

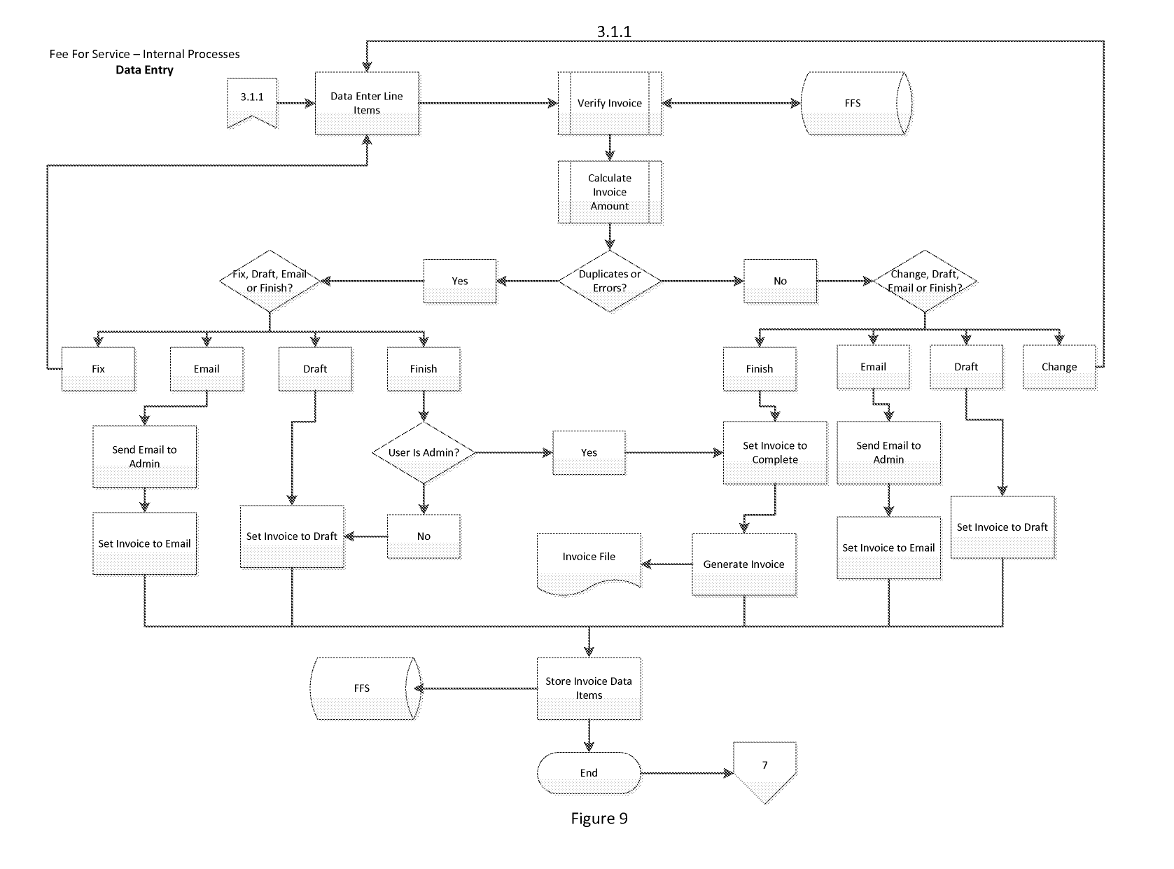

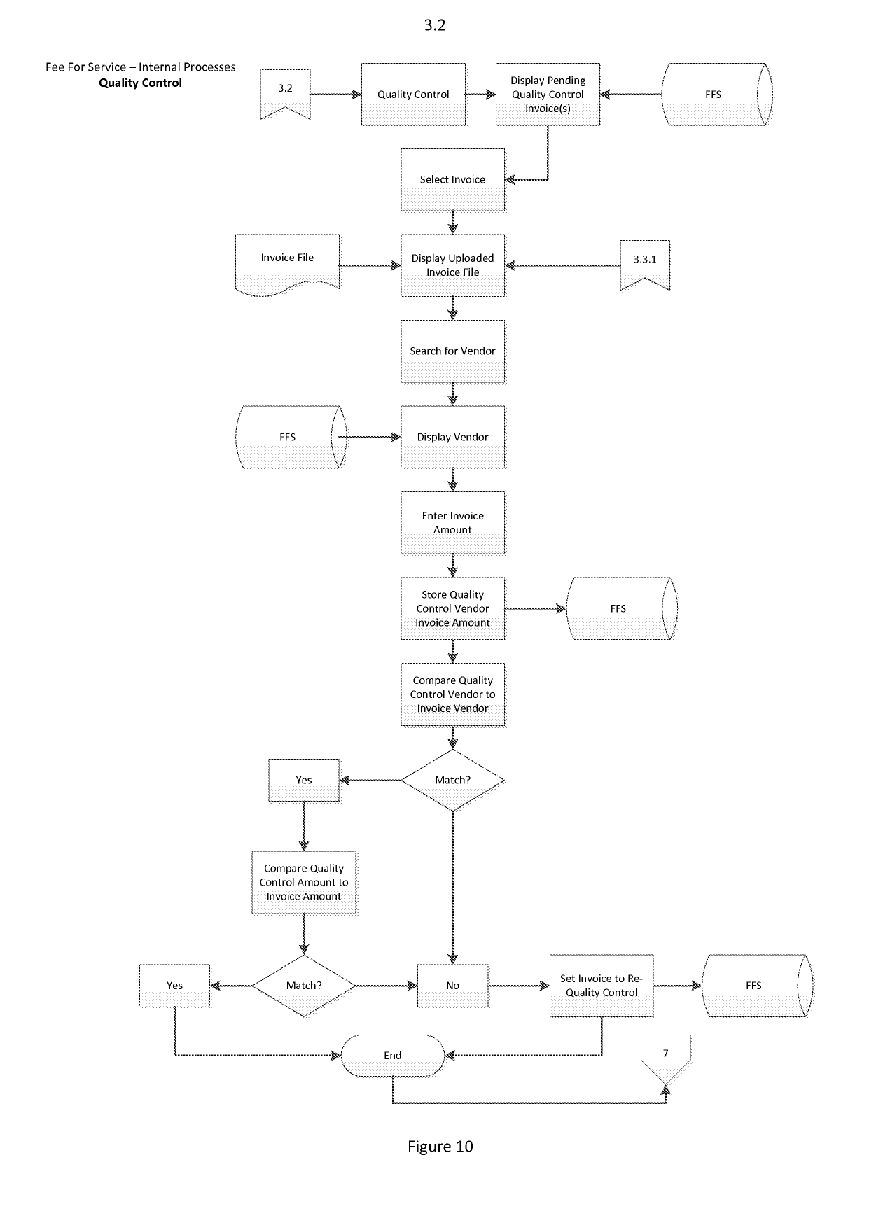

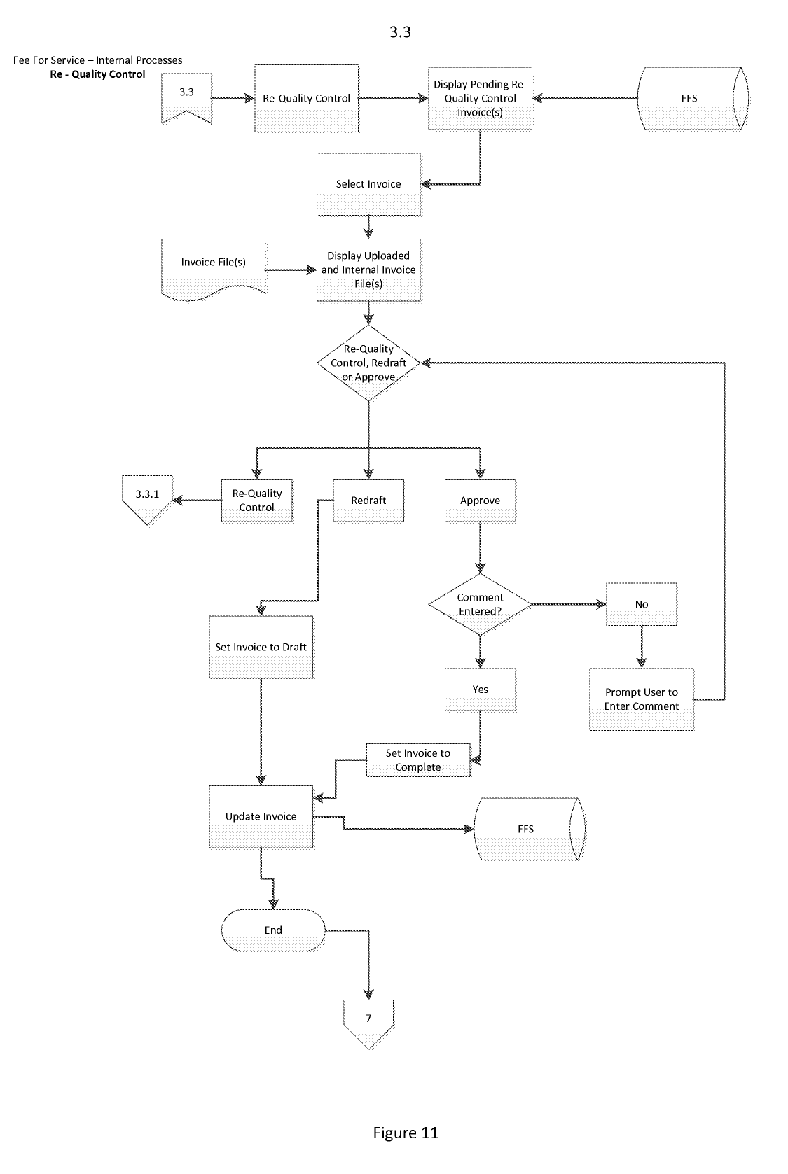

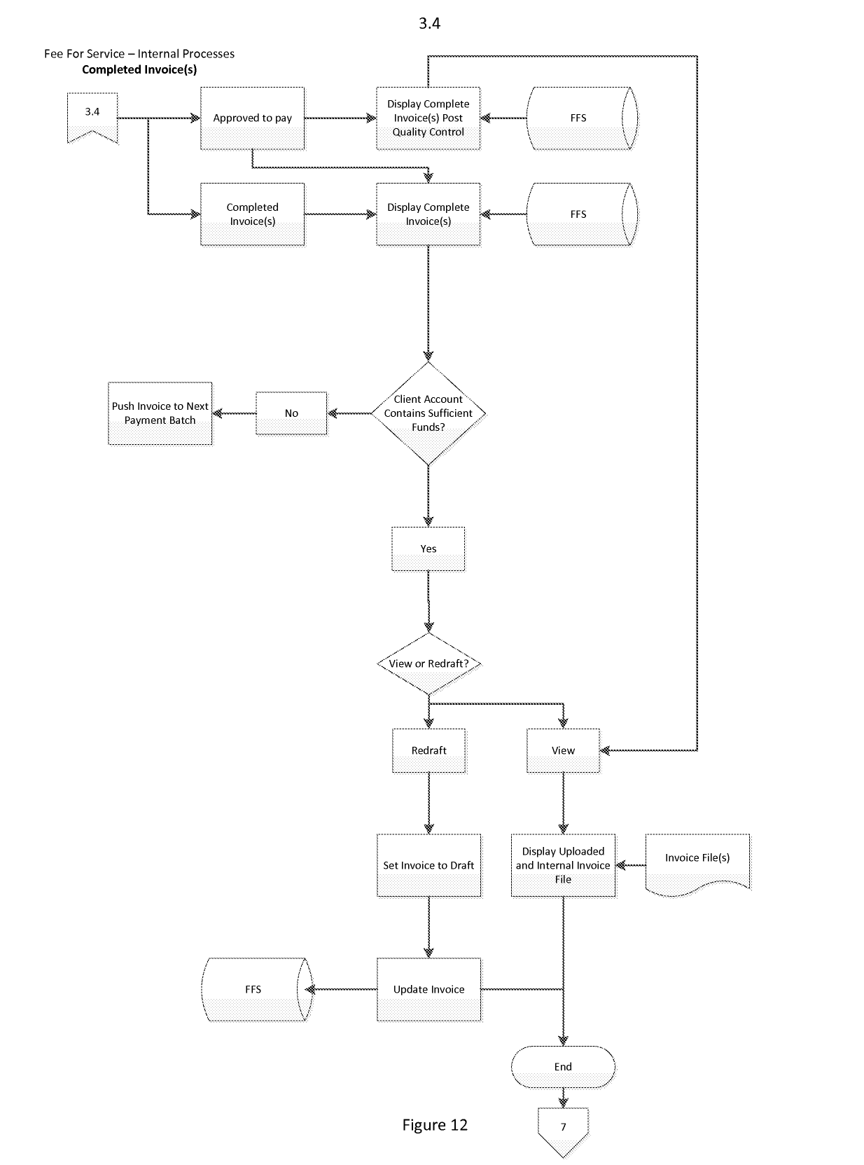

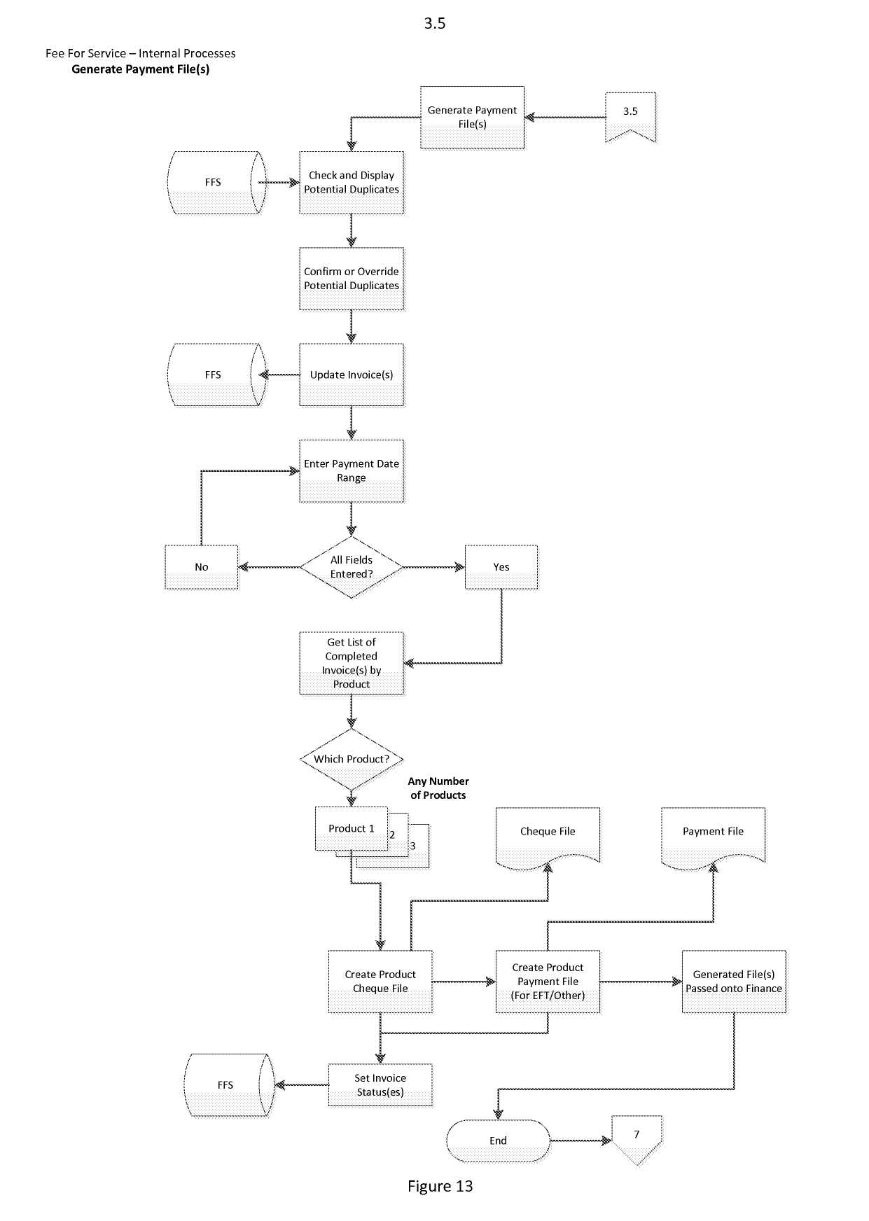

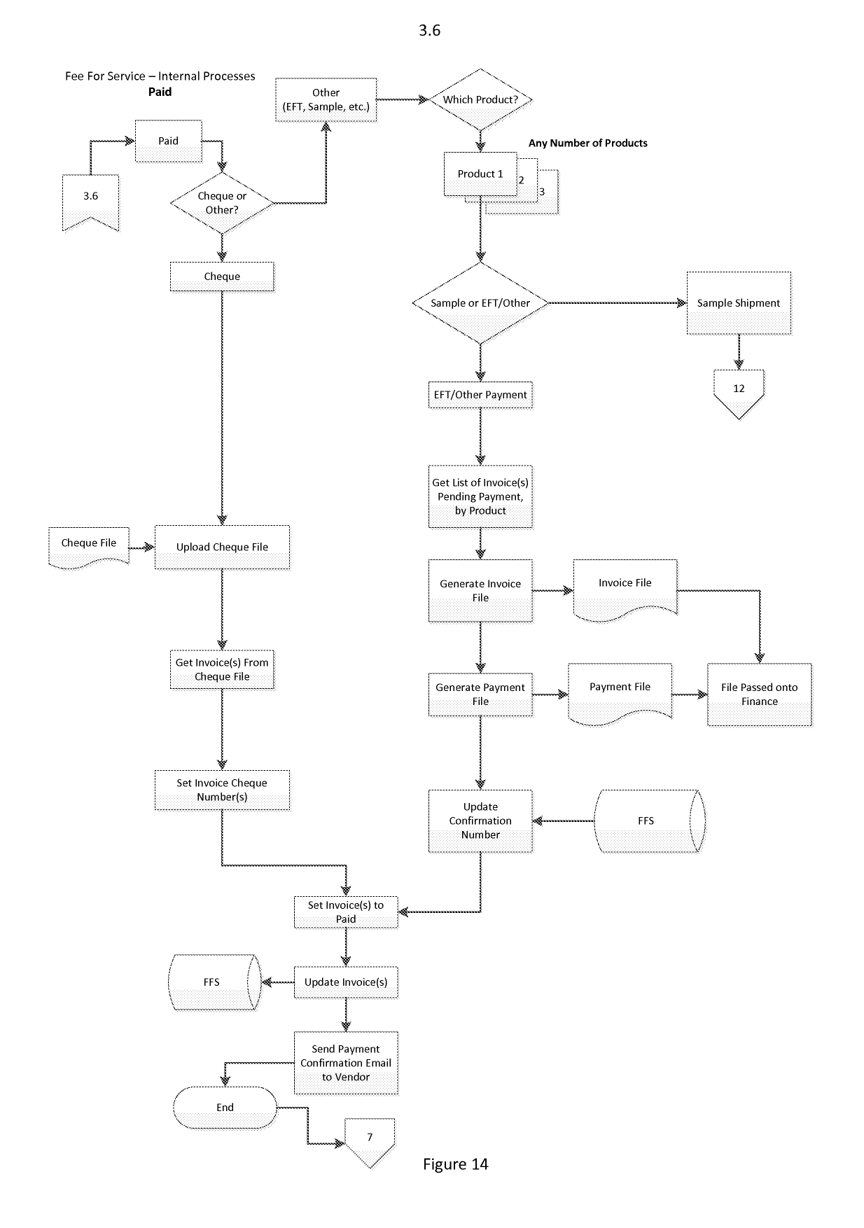

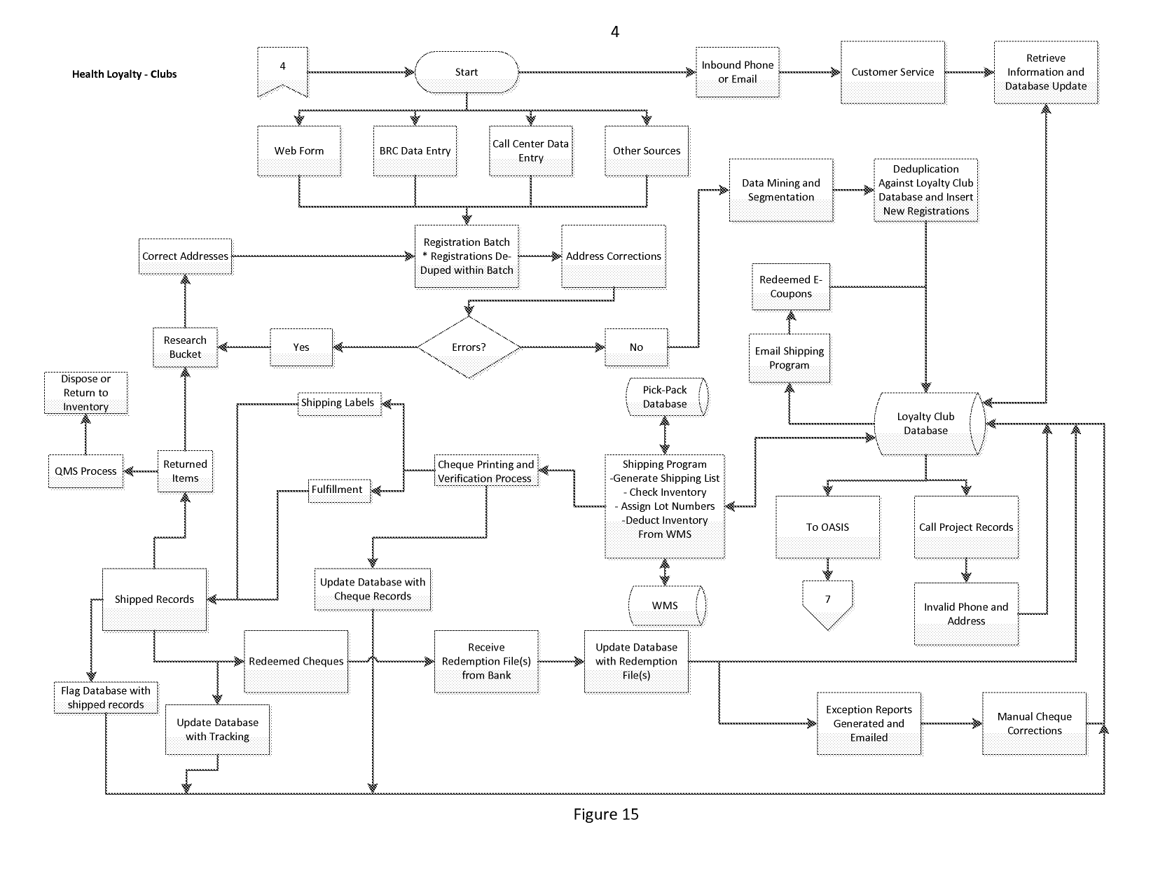

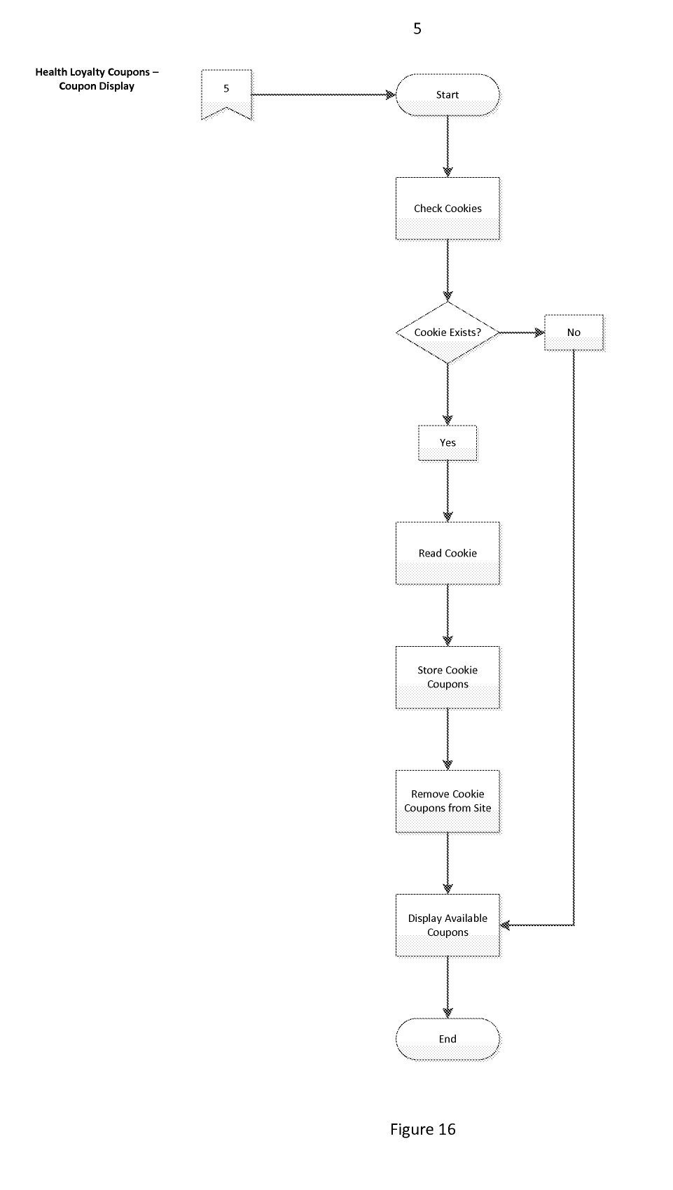

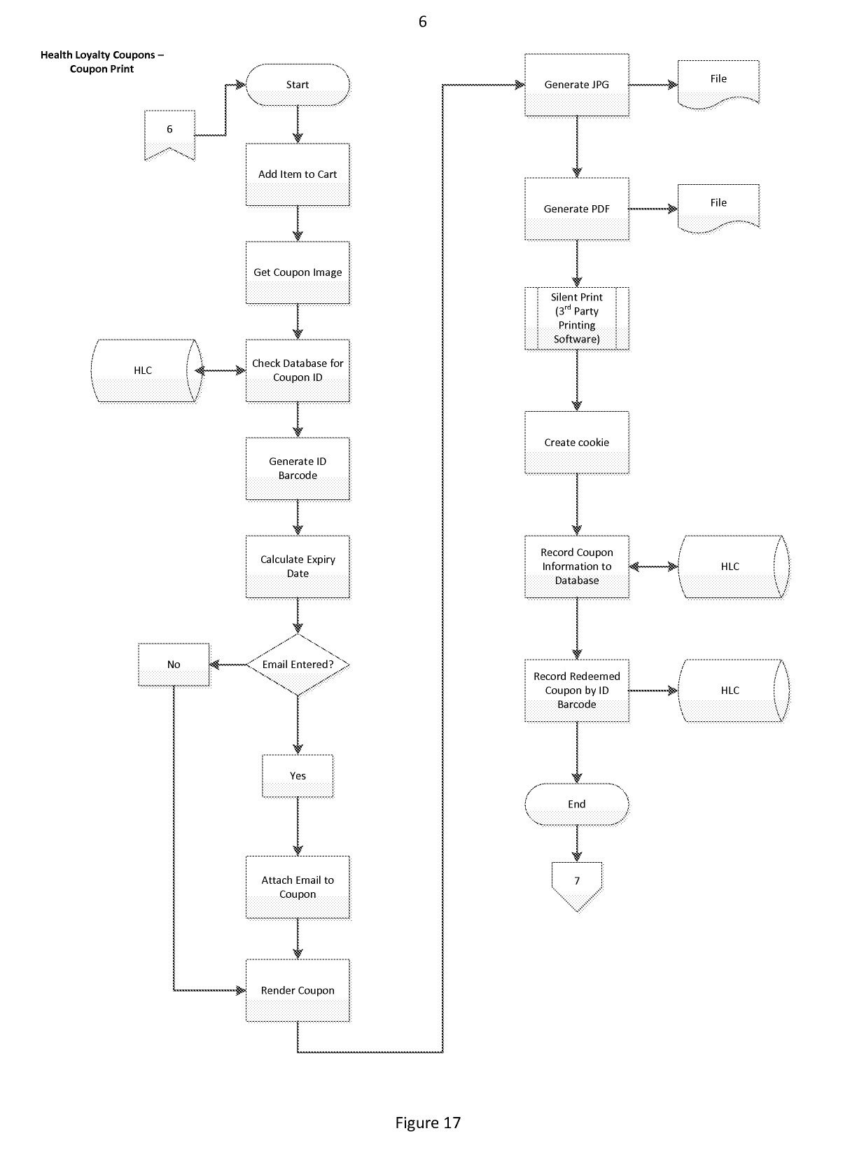

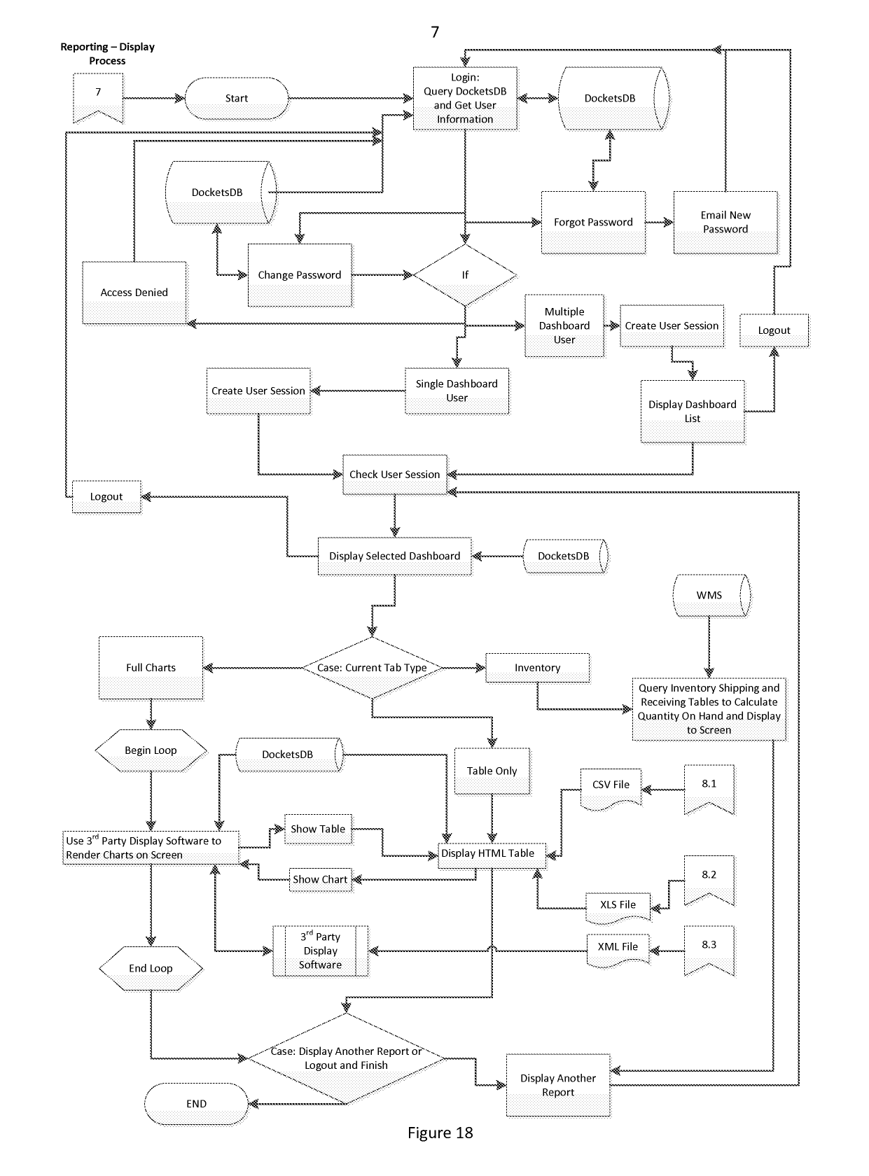

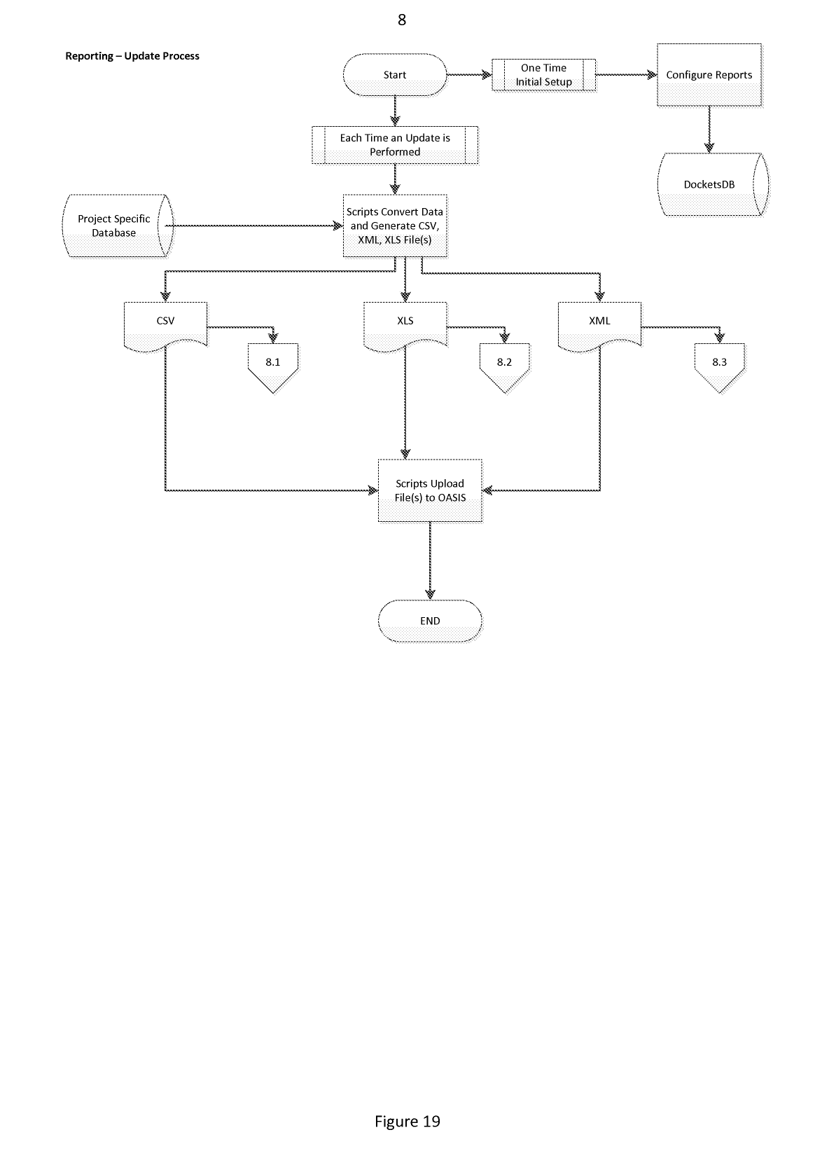

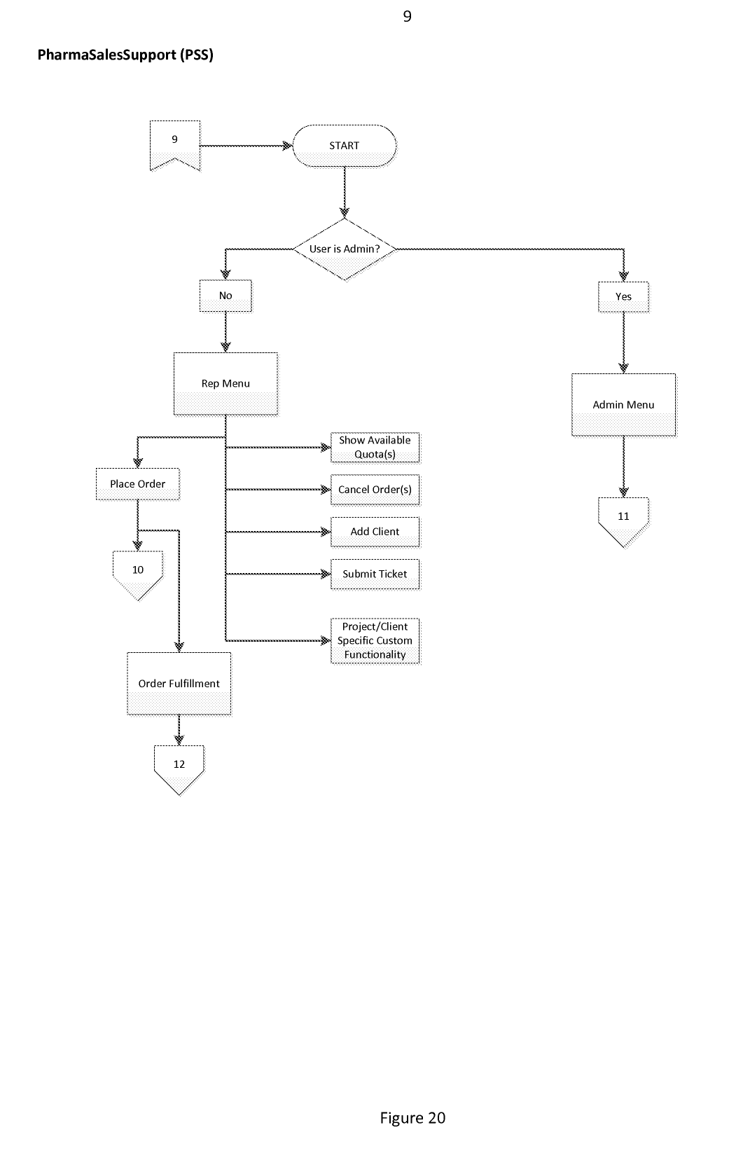

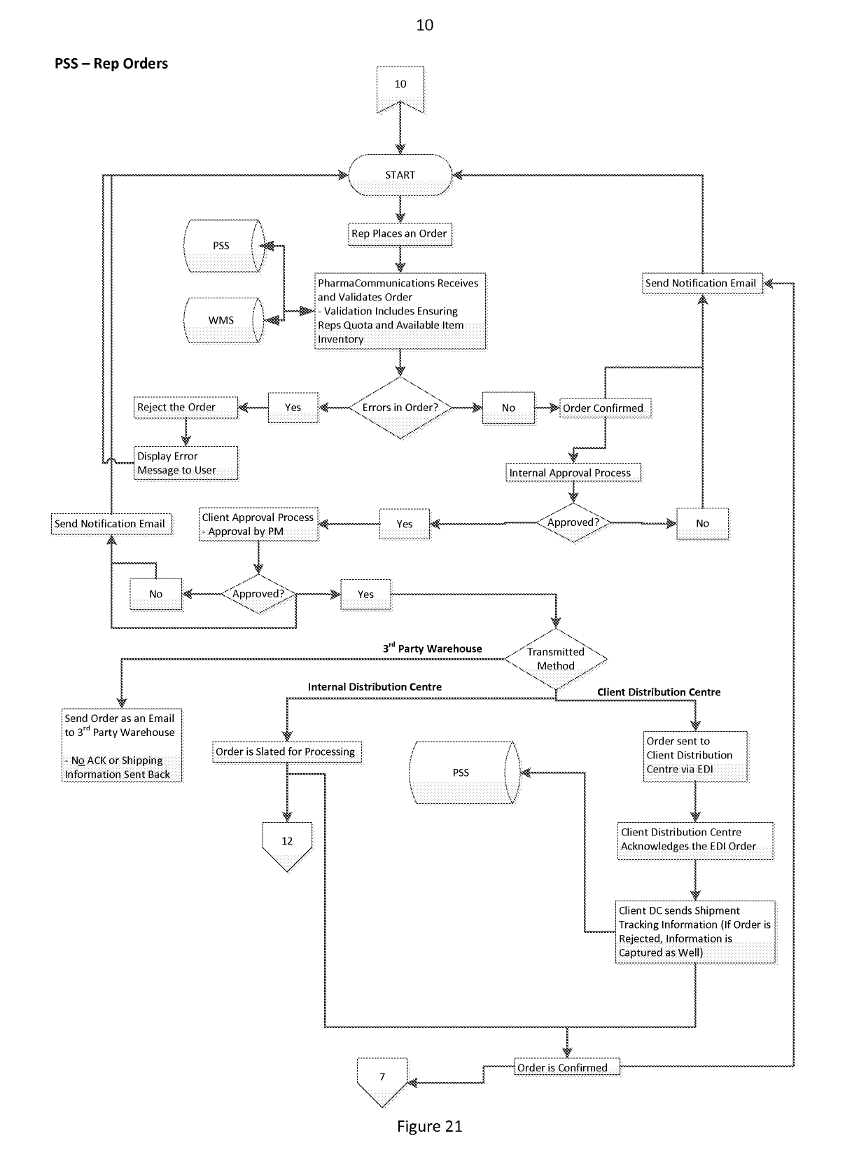

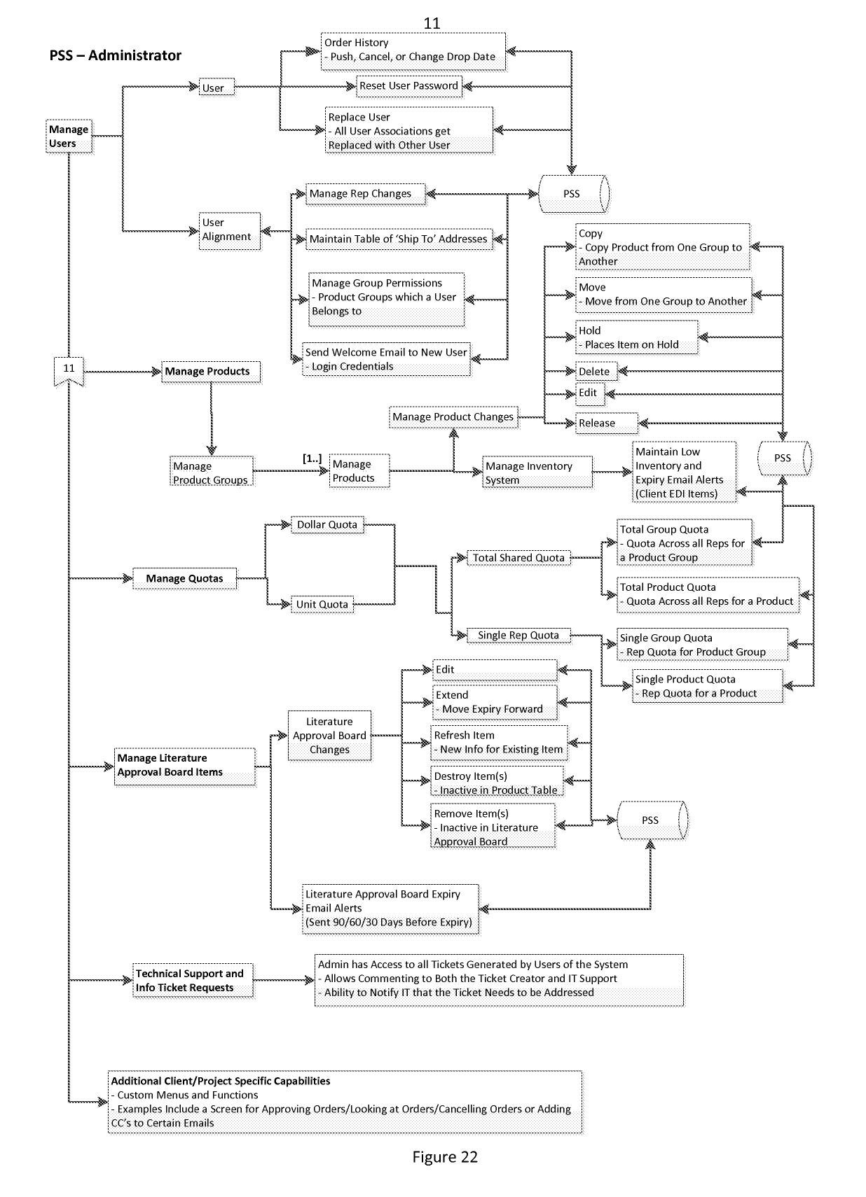

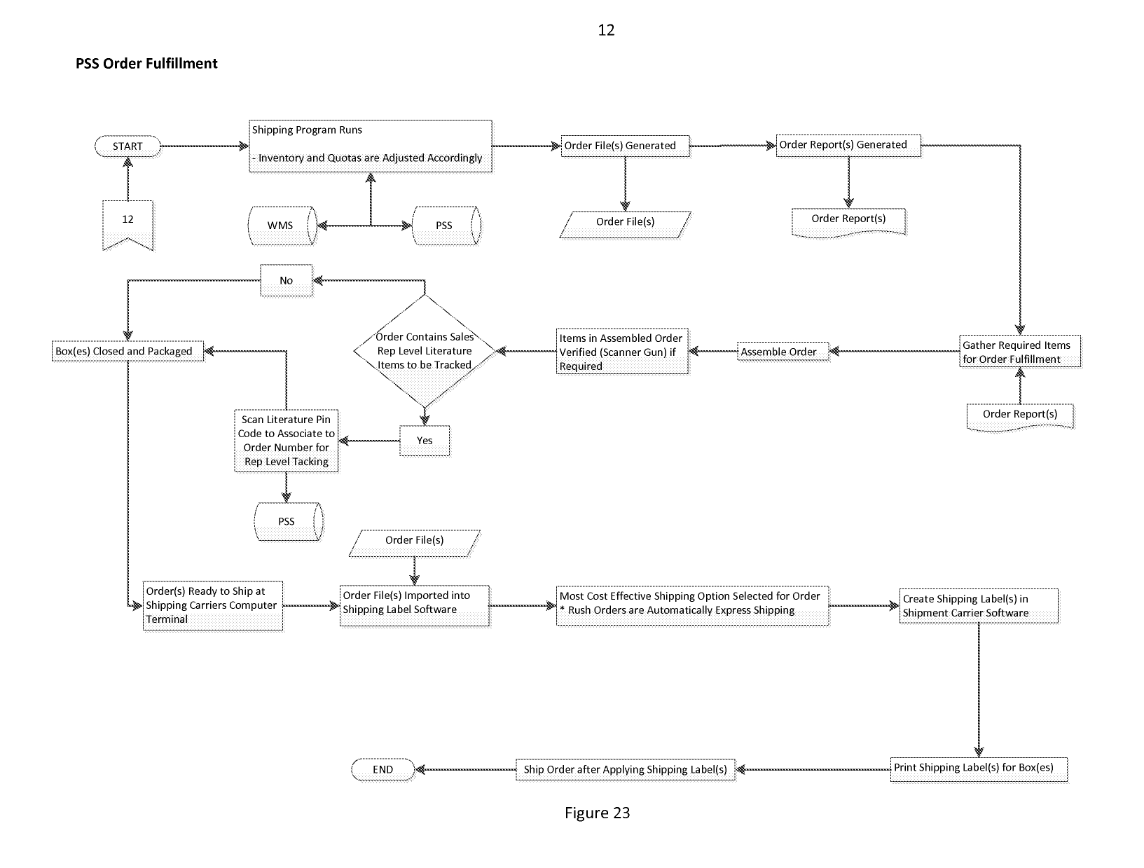

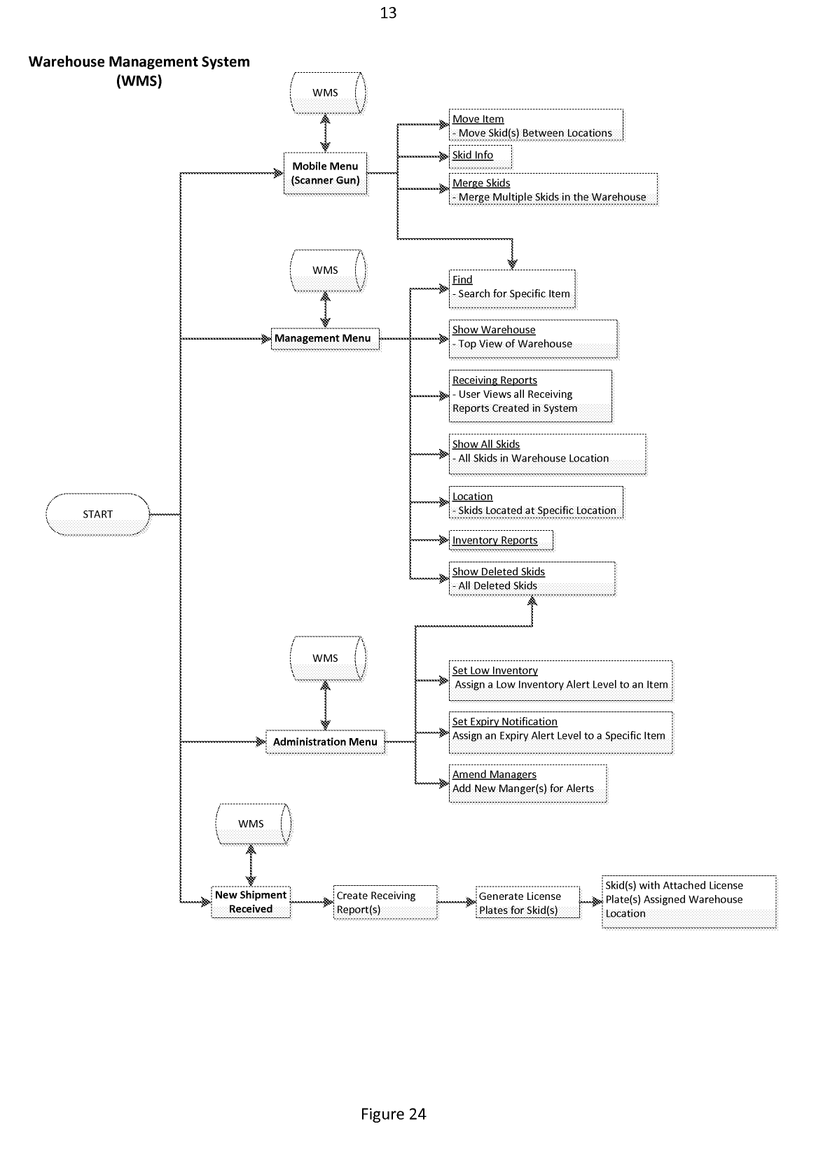

FIG. 3 illustrates a Health Loyalty Master flowchart having the following:
Customer Subsidiary/Reimbursement Program 1 and 1.1.1 which is more fully particularized in FIG. 4, and FIG. 5,
FFS—Client Upload Portal 2 which is more fully particularized in FIG. 6,
FFS service—Internal Processes 3 which is more fully particularized in FIG. 7,
FFS—Internal Processes Data Entry 3.1 which more fully particularized in FIG. 8,
FF service—Internal Processes Data Entry 3.1.1 which is more fully particularized in FIG. 9,
FFS—Internal recesses Lathy Control 3.2 which is more fully particularized in FIG. 10,
FFS—Re-Quality 3.3 which is more fully particularized in FIG. 11,
FFS—Internal Processes Completed Invoice(s) 3.4 which is more fully particularized in FIG. 12,
FFS—Internal Processes Generate Payment File(s) 3.5 which is more fully particularized in FIG. 13,
FFS—Internal Processes Paid 3.6 which is inure fully particularized in FIG. 14,
Health Loyalty—Clubs 4 which is more fully particularized in FIG. 15,
Health Loyalty Coupons—Coupon Display 5 which is more fully particularized in FIG. 16,
Health Loyalty Coupons—Coupon Print 6 which is more fully particularized in FIG. 17,
Reporting—Display Process 7 which is more fully particularized in FIG. 18,
Reporting—Update Process 8 which is more fully particularized in FIG. 19,
PSS 9 which is more fully particularized in FIG. 20,
PSS—Rep Orders 10 which is more fully particularized in FIG. 21,
PSS—Administrator 11 which is mare fully particularized in FIG. 22,
PSS—Order Fulfillment 12 which is more fully particularized in FIG. 23,
WMS 13 which is more fully particularized in FIG. 24.

Internal Processes relate to functions occurring in the back office.

Customer Subsidiary/Reimbursement Program FIG. 4

Generally speaking, users of the system 100 include healthcare providers or vendors such as doctors, nurses and clinics which can be reimbursed for certain services they provide to healthcare users or patients or users in some cases a medical clinic does not charge patients, but rather the pharmaceutical company. When the vendors provide the services the vendors' invoices are uploaded to a back office for processing. The third party or back office determines who to pay and how much to pay. Thereafter the third party or back office generates the cheques and mails them or dispatches them by electronic fund transfers or the like. The third party or back office charges the pharmaceutical company for this service, pays the doctor and therefore the patient does not pay certain doctor fees if they purchase the pharmaceutical company's product.

Generally speaking a user, is shown as 1 in FIG. 1. A user connects with the internet and is presented with a login screen on a computer device such as a desktop, laptop, tablet, personal phone or the like. The user such as a healthcare provider enters their credentials to be authorized against the Fee For Services FFS Database as shown in FIG. 4.

Once authenticated the user is prompted to select an Excel file to upload. The FPS Database is used to verify that the file has not already been uploaded, if the file has already been uploaded the user is navigated to the upload step if the file has not been uploaded, the contents will be verified. If the file contents are invalid, the user will be navigated back to the upload step. The data will be run through third party address correction software as shown in FIG. 5 and import records with correct addresses into the FFS Database.

Based on this data, payees and invoices are generated by the System 100. These are entailed to finance which prints the cheques and then mails them out. The cheque file is imported into Uniform, where the cheque number and paid date are associated back to the invoice.

FIG. 4 illustrates generally the sequence for a Customer Subsidiary/Reimbursement Program such as reimbursement for services that a doctor may perform. Such healthcare provider or customer would log in and be authorized to access the users database in order to be reimbursed for Fees For Services (FFS) to be entered into the database, if the customer is authorized they can browse and select or upload an Excel tile which includes therein the different services and the amount for reimbursement for such services.

For example, if there is an injection for insulin or the like, the service provider such as the nurse or doctor would be reimbursed in accordance with the pay scale outlined in the Excel sheet. In other words the Fee For Services (FFS) database is accessed and the contents validated.

Customer Subsidiary Reimbursement Program, FIG. 5

Once the contents are validated from FIG. 4, a subset of the Excel file may be deconstructed to a table. An address can be associated with the customer in as with the Fee For Services provided and checks can be generated to payees while recording invoices to record internal transfers.

There is an export and email to the payees and invoices filed to finance where finance prints the cheques and mails them out.

Fee For Service—Client Upload Portal, FIG. 6

FIG. 6 illustrates the Fee For Service Client Upload Portal Portion 2 of the System 100 which requires a login and an authorization by a users database.

Generally speaking the healthcare provider or vendor performs some service for a patient or user at a monetary discount. Vendors need to be reimbursed for the discount to the patient. In this ease the vendors upload a tie which contains invoices for every service such as providing an injection that is administered. In most cases the file consists of a PDF file of a handwritten invoice.

During this process a healthcare user is presented with a login screen and the credentials are authorized against the FFS Database. If the information entered is incorrect the use is redirected back to the login screen. Once authenticated the user is navigated to the upload menu from which the user selects a product. Once selected the user selects which PDF tile to upload. A hashtag is generated and the PDF file is stored under this hashtag name. If no invoice number is entered, the invoice date is converted into the invoice number. Thereafter a raw file record is created in the HS Database and link uploaded tile to this record.

One may upload a menu which Shows on a screen services that can be provided and a payment schedule. Hash tags can be generated and the invoice entered so as to create a file record and a database and link an upload file to a file record.

Once all of the invoices have been uploaded we move to the back office in FIG. 7.

Fee For Service—Internal Processes, FIG. 7

The Fee For Service—Internal Processes 3 illustrates the next steps similar to the above, to determine Whether the user is an administrator or not. We don't want for example to have a customer service representative to be able to issue a cheque. If so FIG. 7 displays both the admin menu and the regular user menu, otherwise only display the user menu. The user menu comprises:
1. Data Entry 3.1
2. Quality Control 3.2

The Admin menu comprises:
1. Re-Quality Control 3.3
2. Completed Invoice 3.4
3. Generate Finance Files 3.5
4. Paid 3.6

FIG. 7 illustrates the Fee For Service process which includes the step of identifying a user or an administrator whereby the user will he directed to the user's menu 3.1 and 3.2 to be described herein.

On the administration side, the administrator will be directed to an administrator menu 3.3, 3.4, 3.5, and 3.6 to be described herein.

Fee For Service—Internal Processes Data Entry, FIG. 8

FIG. 8 illustrates a user menu for data entry 3.1.

The Data Entry process generally comprises
1. Display Invoice pending Data Entry. This allows the user to select an invoice, which brings up a PDF uploaded by the client.
2. If the Invoice has Raw Status, create an invoice with Draft Status (ie park the invoice) using vendor's information in FFS Database.
3. If the Invoice has Draft Status get the vendor and invoice information from the FFS Database.
4. Display the Invoice and Data enter line items
5. Verify the Invoice, calculating the total invoice amount.
   (a) If the Invoice has duplicates of errors fix it, email Admin to approve, set to Draft, or set it to complete (as appropriate).
   (b) If there are no errors in the Invoice: make a change, complete the Invoice, email Invoice to Admin or set the Draft.
6. Store all Invoice data including the line items in the FFS Database.

FIG. 8 illustrates the general steps for data entry which comprises the steps of displaying pending Invoices from the FFS Database. The invoices are selected from the invoice file so as to display uploaded invoice files. Thereafter the invoice status can comprise of Raw Data which will include the steps of searching for the vendor, displaying the vendor and creating the invoice at which invoice is then in a draft form.

Fee For Service—Internal Processes Data Entry, FIG. 9

FIG. 9 illustrates another component of the data entry 3.1.1 whereby there is a data enter by line in regards to the items utilized to calculate the invoice amount whereby duplicates or errors are detected if they exist. If duplicates or errors exist they an either fixed, emailed or a draft of an invoice prepared or finished, as shown in the flowchart. If the errors are fixed, they are once again verified as shown. Alternatively, they may be sent by email to admin whereby the invoice is set to be emailed. Alternatively, the invoice may be set to a draft state as shown.

If there are no duplicates or errors as shown in FIG. 9, the invoices can be either finished, emailed, put in a draft state, or changed as shown. If the invoices are finished, the invoices can be set to complete whereby PDF invoices, for example may be generated to Pharma clients. Alternatively the invoice may be emailed to admin or the invoices is set to draft or changed as shown. The invoices are stored as invoice data items in a Fee For Service database.

Fee For Service—Internal Processes Quality Control, FIG. 10

Generally speaking the Quality Control 3.2 comprises:
1. Display pending invoices for Quality Control. When an Invoice is selected, the pertaining uploaded PDF file is displayed.
2. Search for Vendor from the PDF invoice in the FFS Database and display when found.
3. User is prompted to enter the value of the Invoice, which is then saved at the FFS Database.
4. Compare the vendor/invoice amount entered, with that on the invoice submitted. Flag for Re-Quality Control in FFS if the values do not match.

FIG. 10 illustrates the Fee For Service—Internal Process Quality Control 3.2 which comprises:
1. Displaying a pending quality control invoice stored in is Fee For Service database,
2. Selecting the invoice,
3. Displaying the uploaded invoice file,
4. Searching for the vendor,
5. Displaying the vendor from a Fee For Service database,
6. Entering the invoice amount,
7. Storing the quality control vendor invoice amount in a Fee For Service database,
8. Comparing the quality control vendor to the invoice vendor and if there is match, comparing the quality control amount to the invoice amount,
9. If there is no match then the invoice is Set to re-quality control which information is stored in a Fee For Service database.

Fee For Service—Internal Processes Re-Quality Control, FIG. 11

Generally speaking the Re-Quality Control 3.3 comprises the following:
1. Display pending Invoices for Re-Quality Control. When an Invoice is selected, the pertaining uploaded PDF file is displayed.
2. There are three options at this point:
   (a) Re-Quality Control: in this case, go through the Quality Control process again, so start from step 2 in the Quality Control Process.
   (b) Re-Draft: set the invoice to a draft in the FFS Database.
   (c) Approve: enter a comment about why this invoice has passed this Quality Control. If there is no comment provided, user is prompted until they enter a comment. The invoice is marked as complete in the FFS Database.

Fee For Service—Internal Processes Completed, FIG. 12

Generally speaking the Complete Invoices 3.4 comprises:
1. Display Invoices which have been completed and which are approved to be paid, pulled from the FFS Database.
2. User can view or re-draft the Invoice:
   (a) Re-Draft: set the Invoice as Draft in the FFS Database and.
   (b) View: displays the PDF invoice generated through data entry.

FIG. 12 illustrates the flowchart for Fee For Service internal processes for completed invoices 3.4 that includes the step of approval for a payment whereby the invoice is displayed after quality control from the Fee For Service database.

Thereafter the client account is checked to see if there are sufficient funds. If there are sufficient funds the invoice may be updated and paid for from the funds available. If there are insufficient funds, the invoice may be pushed to the next batch payment.

Fee For Service—Internal Processes Generate Payment Files, FIG. 13

FIG. 13 illustrates the flowchart for internal processes in generating a payment 3.5. The System 100 generates payment files as shown which are displayed and checked for any potential duplicates. There is a confirmation or override regarding potential duplicates so as to update the invoices. Thereafter there is an entry of the payment date range so as to obtain a list of completed invoices by product for example.

The products may be identified and consist of any number of products to create a product cheque file so as to create a product payment file for electronic funds transfer or other means of payment. Thereafter the generated files are passed on to finance as shown. The finance team can upload the files into QuickBooks or the like.

In other words the method shown in FIG. 13 generally consists of:
1. Generate a finance file so as to check for potential duplicates. Duplicates are flagged and are then confirmed or overwritten in FFS
2. Based on the to/from payment date, a list of completed invoices are obtained and stored by product.
3. A product-specific check file is created and product-specific electronic fund transfer file is also generated.
4. Email check files and electronic fund transfer files are routed to finance.

Fee For Service—Internal Process Paid, FIG. 14

FIG. 14 illustrates the Fee For Service—internal process paid 3.6 flowchart.

Generally speaking FIG. 14 illustrates the steps of:
1. If paid by cheque uploading Excel cheque files and using the cheque numbers in the file to update invoices in FFS Database as paid.
2. If paid by electronic fund transfer then
   (a) obtain a list of paid electronic fund transfers by product
   (b) create an Excel bill payment file and set invoices in paid electronic fund transfer to paid in the Fee For Service database
      (c) email bill payment files to finance and send payment confirmation email to vendor.

When the cheques have been paid, invoices paid by electronic funds transfer and appropriate taxes paid, the financial institution sends a file for download with details of payment, cheque numbers, paid and the like for backup information.

Health Loyalty Clubs, FIG. 15

The system 100 described herein includes selected groups 4 such as Health Loyalty Clubs selected to market and offer for sale products and services to such groups. A number of different groups can be developed and tracked. For example there can be:
1. Elderly Group—the elderly group may require a nutritional boost. They may call in or sign up on line in response to a marketing campaign to receive for example a free promotional sample or discounted coupons. Once in the group or Club they will be sent promotions from time to time, or receive product with “neck tags” with discount coupons as previously described.
2. Diabetic Group
3. Expectant Mothers; and so on

Various sales campaigns may be devised to increase sales to selected groups or Health Loyalty Clubs. The Loyalty Groups can be segmented, for example Friends of the Elderly, Medicinal Users, Bargain Hunters, Fitness Buffs or the like.

FIG. 15 illustrates the health loyalty club flowchart 4. FIG. 15 illustrates the health loyalty—clubs 4. In particular the chart in FIG. 15 indicates that
1. the users register to the health loyalty club through some source including a web registration form, business reply card (BRC), or a telephone call or the like.
2. the data is stored in the pertaining health loyalty club database as raw record, after which the registrations go through address corrections software. Registrations which do not make it through the address correction are directed of into a separate bucket to be researched further.
3. the registrant's records are running through a data mining model, which assigns the registration into a specific program segment (which dictates the offerings and mailings sent to this registration). The registration is run through a de-dupe process to ensure its uniqueness within the health loyalty club. The registration is then considered processed and part of the health loyalty club. An inbound phone call or email to the customer service mailing to manual registration data adjustments to the health loyalty club database.
4. registrations receive mailings, based on the heuristics established for the program, which contain various samples, literature and monetary cheques.
VBA scripts i.e., shipping programs query the health loyalty club database to identify applicable registrations, and gather information required to print cheques. Cheques are printed and verified at a local distribution centre and then are mailed out to the registrations identified, Database records are created for the shipped cheques in the health loyalty club database.
After a cheque is redeemed and the cheque data has been downloaded from for example, a bank, the redemption data is stored in the health loyalty club database. VBA scripts query the health loyalty club database for a new cheque redemption data, and the pertaining shipping records and data are uploaded by the script.
When a mailing is returned, the information is data entered into the System 100. Scripts query the health loyalty club database for return mail records, and then the scripts update the pertaining shipping records with this information.
5. Emails with redemption coupons can be sent to club registrations. In such cases VBA scripts query the health loyalty club database to identify applicable registrations (based on heuristics established for club). Emails are then sent using third party mailing software. Scheduled VBA script update redemption info as coupons are data entered back into the system.
6. Call projects exists which reach out to registrations in the club. If a wrong address or phone information is discovered such information is updated to the loyalty club database.
7. The above-mentioned data is then made available for the pertaining health loyalty club.

Health Loyalty Coupons—Coupon Display, FIG. 16

FIG. 16 generally illustrates the steps for displaying coupons which comprises of:
1. check whether the user has an cookies which pertain to the webpage.
2. if cookies exist, read them and do not display the coupons which do not pertain
3. render all other available coupons on the screen.

Health Loyalty Coupons—Coupon Print, FIG. 17

FIG. 17 generally illustrates the Health Loyalty Coupons—Coupon Print 6.

Generally speaking, FIG. 17 illustrates the following steps:
1. the user adds an item to the cart, which prompts the system to retrieve the coupon images,
2. retrieve the coupon identification from the Health Loyalty Club (HLC) database and then generate a barcode and expiration date.
3. if an email is entered, attach an email to the coupon,
4. the coupon is rendered and a jpeg and pdf file is generated,
5. silent printing using third party printing software can be utilized,
6. create a cookie for the coupon and record the coupon information into HLC database,
7. redeem the coupon gets recorded in the HLC database upon receiving it back.

Reporting—Display Process, FIG. 18

FIG. 18 illustrates the Reporting Display Process 7 to prepare reports on any product or service provided by clients. It is the client that will log in to see how a campaign is doing.

In particular, the reporting display process comprises a web-based client facing application, which displays data to users such as the healthcare providers using charts and tables. Information presented to the user is determined by configuration one internally, during the initial setup of the user's reports and dashboards.

Generally speaking the display process comprises:
1. the user such as the healthcare provider is presented with a login screen which authenticates through Dockets Database. The system allows the user to change their password or have the password emailed to them in the case they have forgotten it in a manner well known to those persons in the art.
2. if the user has multiple dashboards assigned to them, they are presented with a list of everything available. If the user only has one dashboard, this dashboard is automatically selected. The user can logout at any point in the process.
3. there are three types of distinct reports that can be rendered depending on the setup of the dashboard;
   (a) full charts—for each chart that is in the report, query Dockets Database to get positioning and XML file location, which is supplied to third party display software to render chart on screen. Third party display software provides the Flash-based interactive graphs. Graphs can be configured to all of the users to view the information as a table in their browser and/or download this table as an Excel file.
   (b) table—query Dockets DB to get required CSV file and display as HTML table.
   (c) inventory—query pertaining database inventory shipping and receiving tables to calculate the quality on hand for each object pertaining to the project. Display the inventory for the project.
4. the user can navigate to various points in the dashboards, and to other dashboards if they have multiple dashboards assigned or they can logout.

For example one report may show how many invoices have been paid for particular month or time segment. Other reports can show how successful a redemption program has been by region or time period, what commissions have been paid on neck tags. Furthermore clients such as pharmaceutical companies can look at Health Clubs to determine what sales campaigns or coupon distributions have been successful. The reports can be tailored to see what type of person redeems the coupons, when they redeem it, what region of a county has a better redemption rate. Such computer data mining is useful to tweak a future offering, or segment of the population. Furthermore statistical reports can be prepared to determine whether a $2 dollar discount coupon was more effective than a $3 or $4 dollar discount coupon.

Furthermore reports can be run on WHS, PSS, and FPS.

Reporting—Update Process, FIG. 19

FIG. 19 generally illustrates the Reporting-Update Process 8.

Generally speaking the update process includes the following steps:
1. an initial setup per dashboard is required in Dockets DB to configure each report specifying tabs, charts, and tables including positioning and XLS, CSV, and XML file locations.
2. pull report, pertaining VBA scripts, query databases with relevant data, which is transformed into the required XLS, CSV, and XML files which reads and then renders.
3. VBS scripts invoke the appropriate VBA scripts, and then upload the generated XLS, CSV and XML files to the proper location.

PSS, FIG. 20

FIG. 20 generally illustrates the Pharma Sales Support 9. In order to start a user logs in whereby such user can comprise of two basic categories of users, namely:
1. Rep; or
2. Admin

The representative would follow the rep menu while the admin user would follow the admin menu as shown in FIG. 20.

An Administrator would be able to change configuration settings.

When a rep logs in to order, the rep can see all of the products and samples that are available. Most of the samples have quotas attached to it so the particular rep can only order the quotas available such as for as example order 10 of the samples per month. Accordingly, the Administrator can set up or edit the quotas. Furthermore, an Administrator can edit the quotas on a per rep level. In other words, if the representative has many reps, one rep may have a quota of 100 while another rep has as different quota. Such changes can be seen by the rep as particularized in FIG. 21.

More fully particularized in FIG. 22, the Administrator can manage products, manage product groups, manage quotas.

In some cases, pharmaceutical companies have more than a thousand different products so that the back office can group them to make it easier for the pharmaceutical companies to find their products when they want to order. Such products may be warehoused in the pharmaceutical company's warehouse or as in many eases such products are warehoused at a back office. In other words, the Administrator can edit a group, change the name of a group, set up a product manager and product manager's email to a particular group, they can get a rep's permission for a particular group, and quotas for a particular group. Again, as outlined in FIG. 22, the Administrator can move from one group to another or copy product from one group to another, move a particular product, they can edit, they can delete a copy, change the quotas, or look at inventory alerts. The Administrator section includes a plurality of menus that can he configured air the reps to execute.

In some cases, the rep can actually click the email address of a particular rep and log in as that rep. In some cases, some companies authorize that admin actually place the orders on behalf of the reps. The Administrator referred to herein is the Administrator of the pharmaceutical company. And in some cases, the Administrator has many representatives below them. It is not unusual for reps to be responsible for a certain territory. In many cases, the turnover rate for reps can be high so that the name and email address of the rep can be changed.

PSS—Rep Orders, FIG. 21

FIG. 21 illustrates PSS-Rep Orders where the Pep places an order. Generally speaking every step below Rep places an order represents what the back office processes through the system 100.

FIG. 21 illustrates basically the hack end what is not seen by the rep. In other words, the rep places an order and again the back office checks for available inventory. If there is not enough inventory, the order cannot be processed. Furthermore, the quotas are validated, in other words, does the rep have enough particular quota far the order. All of this is done automatically. If the rep places an order over the quota an error message will appear.

If there is no error the order is confirmed and submitted to the back office for an internal approval process. Once the order is approved internally art email is sent for example to an administrator in the pharmaceutical company for example for approval. If the order does not get approved a notification is sent by email to the rep that placed the order saying that the order was not approved and why. It is up to a particular pharmaceutical administrator to provide the reasons why an order is not approved. Some reasons that may be provided include:
1. the pharmaceutical company wants to reserve some of the samples for another purpose;
2. too much is being ordered.

A product can be distributed by a number of means including through the client Distribution Centre or in other oases from the back office internal Distribution Centre as more fully particularized in FIG. 21. In many cases the product is shipped out of the third party back office warehouse as a service provided to the pharmaceutical companies. However, some clients or pharmaceutical companies prefer to ship some of the product out of their own distribution centre. If that is the case, then the back office transmits the order information by Electronic Data Interchange right into the client's warehouse system. The order is then processed at the pharmaceutical warehouse. If the order is being shipped out of the pharmaceutical warehouse distribution centre the pharmaceutical company will send the back office the tracking information, if the order was not rejected, the actual amount of the units that were shipped and so on. In other words, the pharmaceutical company will send via EDI an update to be processed by the back office system to record the tracking number if the reps access the back office system 100. The tracking number is required to look up the shipment to know when the product is expected to be delivered and so forth.

PPS Order Fulfillment—FIG. 23

FIG. 23 illustrates the flowchart for PSS Order Fulfillment 12.

FIG. 23 illustrates how the hack office picks up and ships orders in the back office warehouse. A shipping program interface is displayed on, a screen which may show all of the orders queued up. In some cases one order is processed, or flex batches of orders can be processed. An order report is generated and may be printed and all the items may be gathered for order fulfillment. Someone can take a cart around the warehouse, get all of the particular items that are on a particular order. The products are assembled in accordance with the order and the items are then verified by for example a scanner gun. In some circumstances the bar code or the UPC code is scanned or the lot number code is scanned on a particular product.

Some products have a little extra bar code tag on the product. For example some reps take these bottles with the neck tags wrapped around them for distribution to the clinics. If a patient is at a clinic and decides that they may want to try a drink in a bottle, the neck tag can be ripped off for future use. The neck tag incorporates a discount coupon that can be used for future purchase of the same product. The coupons can incorporate tracking codes so that when a coupon is redeemed the back office is electronically advised of such redemption and associated with the rep that delivered the product to the clinic. All of this is recorded and stored in data. Furthermore the rep may receive a commission on the sate of the product associated with the redeemed coupon.

Warehouse Management System—FIG. 24

FIG. 24 illustrates generally the data source relating to the Warehouse Management System 13 of the back office. In other words the Warehouse Management System holds all of the inventory data which includes all of the products for all of the clients and the current levels of stock.

In particular the administration menus are disclosed that relate to a back end system. In other words PPS is just communicating to the Warehouse Management System to check. One of the main functions is receiving new inventory. When the warehouse gets new inventory such function may be observed under the Receiving Report portion of the menu. The Receiving Report can generate a licence plate which comprises a sheet of paper that prints out with bar codes that include information for a particular skid that is being received. Such information can include item number, the lot number, the company it belongs to, the expiry date if any.

Other items which can be shown on the menu include location of skids, low inventory, expiry notifications and amending managers. The expiry notification is communicated to the pharmaceutical company who will then advise the back office if the pharmaceutical company wants to destroy the product or have it shipped back to them.

The amend managers menu relates to product managers at the pharmaceutical companies where products are linked to a particular product manager. New managers may be added for Alerts. Such Alerts can include expiry alerts or low inventory alerts.

We claim:

1. A method of providing a benefit to a user of a healthcare computer system through the internet comprising:
identifying at least one healthcare provider wherein the identification comprises storing product and/or service data from the healthcare provider and the name of the healthcare provider in a database accessed through the internet;
b. identifying at least one healthcare user accessing the product and/or service, wherein the identification includes storing data regarding the purchase or acceptance of the product or service and the name of the healthcare user in the data base;
c. associating the healthcare provider with the healthcare user and storing the associated data in the database;
d. generating a benefit to one of the healthcare provider or healthcare user.

2. A method as claimed in claim 1 wherein the healthcare provider is selected from a group including a pharmaceutical company, medical clinic, doctor, nurse, and dentist.

3. A method as claimed in claim 2 wherein the healthcare user comprises a patient or user of a healthcare product or service.

4. A method as claimed in claim 2 wherein the benefit comprises recording sales of pharmaceutical products by sales representatives of the pharmaceutical company and automatically generating payment to the pharmaceutical company and the sales representative.

5. A method as claimed in claim 2 wherein the benefit includes generating marketing campaigns that include free sample of product and discount coupons for purchase of product.

6. A method as claimed in claim 2 wherein the benefit includes calculating healthcare provider amounts based on the sale of product and the services provided.

7. A method as claimed in claim 3 wherein the benefit includes providing healthcare user with the product and service at a discounted price.

8. A method as claimed in claim 2 wherein the benefit includes generating a plurality of healthcare groups and tracking the purchasing records of the healthcare users and generating selected reports.

9. A method as claimed in claim 4 wherein the benefit comprises automatically tracking the level of the product in a warehouse.

10. A method as claimed in claim 9 wherein the warehouse comprises either a pharmaceutical warehouse or other warehouse.

11. A method as claimed in claim 10 wherein a hack office records, tracks, delivers product to the healthcare user from the other warehouse.

12. A system to provide a benefit to a healthcare user comprising:
a. a computer server connected to the internet, the computer server having a computer memory for storing sales, support, reporting, fee for service, and warehouse management;
b. at least one healthcare provider computer connected to the internet for connecting with the computer server to enter identification data regarding the healthcare provider product and/or services as the name of the healthcare provider;
c. at least one healthcare user computer connected to the internet for connecting with the computer server to enter identification data regarding the purchase or acceptance of the product or service;
d. the computer server associating the healthcare provider identification data with the healthcare user identification data to provide a benefit to one of the healthcare provider or healthcare user.

13. A system as claimed in claim 12 wherein the computer server includes local servers running scripts for reporting updating.

14. A system as claimed in claim 13 wherein the computer server tracks a plurality of healthcare groups and generates selected reports.

15. A system as claimed in claim 14 wherein the at least one healthcare user computer comprises a computer, tablet, personal digital device, phone or the like.

16. A system as claimed in claim 15 further including a non transitory computer medium for providing instruction to:
a. identify the at least one healthcare provider wherein the identification comprises storing product and/or service data from the healthcare provider and the name of the healthcare provider in a database accessed through the internet;
b. identify the at least one healthcare user accessing the product and/or service, wherein the identification includes storing data regarding the purchase or acceptance of the product or service and the name of the healthcare user in the data base;
c. associate the healthcare provider with the healthcare user and storing the associated data in the database;
d. generate a benefit to one of the healthcare provider or healthcare user.

17. A non transitory computer medium for providing instruction to:
a. identify the at least one healthcare provider wherein the identification comprises storing product and/or service data from the healthcare provider and the name of the healthcare provider in a database accessed through the internet;
b. identify the at least one healthcare user accessing the product and/or service, wherein the identification includes storms data regarding the purchase or acceptance of the product or service and the name of the healthcare user in the data base;
c. associate the healthcare provider with the healthcare user and storing the associated data in the database;
d. generate a benefit to one of the healthcare provider or healthcare user.

18. A non transitory computer medium as claimed in claim 17 further providing scripts for report of updating.

19. A non transitory computer medium as claimed in claim 18 further including selected statistical analysis of said data.

20. A non transitory computer medium as claimed in claim 19 including instructions to report said selected statistical data in chart form.
